(19) United States
(12) Patent Application Publication
(10) Pub. No.: US 2016/0131986 A1
(43) Pub. Date: May 12, 2016

(54) TONER, TONER ACCOMMODATING UNIT, AND IMAGE FORMING APPARATUS

(71) Applicants: Mio KUMAI, Tokyo (JP); Hideki SUGIURA, Kanagawa (JP)

(72) Inventors: Mio KUMAI, Tokyo (JP); Hideki SUGIURA, Kanagawa (JP)

(21) Appl. No.: 14/888,000

(22) Filed: Oct. 20, 2015

(30) Foreign Application Priority Data
Nov. 6, 2014 (JP) 2014-226136

(51) Int. Cl. G03G 9/00

(52) U.S. Cl. CPC G03G 9/0821

(57) ABSTRACT

A toner, including: colorant; resin; and release agent, wherein M_{THF} is 4.0×10³ to 1.0×10⁶, where M_{THF} is molecular weight of a peak-top of a peak whose differential molecular distribution value is maximum in differential molecular weight distribution curve derived from the resin, the molecular weight distribution being obtained by GPC of the toner using THF as solvent, and wherein there is no peak at higher molecular weight side of maximum peak (Pmax) present at a molecular weight of 5×10⁴ or less in molecular weight distribution derived from the resin, the molecular weight distribution being obtained by GPC of the toner using HFIP as solvent, or there are one or more peaks at the higher molecular weight of the Pmax, total peak area is 35% or less of area of the Pmax, and the Pmax has half value width of 3.5×10⁴ or less.

### BACKGROUND OF THE INVENTION

1. Field of the Invention

The present invention relates to a toner, a toner accommodating unit, and an image forming apparatus.

2. Description of the Related Art

In an image forming apparatus, such as an electrophotographic image forming apparatus, and a electrostatic recording apparatus, an image is formed by developing an electrostatic latent image formed on a photoconductor (may be referred to as an “electrostatic latent image bearer,” “latent image bearer,” or “electrophotographic photoconductor” hereinafter) using a toner to form a visible image, transferring the visible image onto a recording medium, such as paper, followed by fixing the transferred image with heat and pressure. When a full-color image is formed, moreover, developing is typically performed using toners of four colors, black, yellow, magenta, and cyan. After transferring visible images of the four colors on a recording medium to superimpose the visible images, the superimposed images are simultaneously fixed with heat and pressure.

Developments of low temperature-fixable toner for the purpose of reducing environmental loads have been actively conducted. Typically, a resin that melts at a low temperature is used in the low temperature-fixable toner, and therefore the toner tends to have poor heat resistant storage stability. Various ingenious ideas have been applied to many of the low temperature-fixable toners, in order to prevent the toner from melting at the temperature around the storage temperature of the toner. As a result, both low temperature fixability and heat resistant storage stability have been achieved at the same time, but there is a further problem in the low temperature-fixable toners, which is lack of durability to folding.

The lack of durability to folding is a phenomenon that the toner presented at a folded part is detached, as a recording medium, such as paper, to which the toner has been fixed, and a disturbance of an image is caused. The durability to folding is secured, if the toner is sufficiently melted upon application of heat, and is adhered in a manner that the toner is tangled around fibers of paper, as in fixing of a typical toner. However, stress, i.e., folding paper, is applied in a folding durability test. Therefore, the toner needs to be adhered to paper more steadily than typical fixing.

Although the aforementioned problem is solved by improving fixability of a toner, such the fixability of the toner adversely affect heat resistant storage stability of the toner. Accordingly, all of the aforementioned problems cannot be solved at the same time in the conventional art.

For example, it is attempted to achieve both improvement of low temperature fixability and durability to folding in Japanese Patent Application Laid-Open (JP-A) No. 2011-237608. However, heat resistant storage stability of a toner is not taught therein. Accordingly, the current situation is that a toner having excellent low temperature fixability cannot achieve both high durability to folding, and high heat resistant storage stability.

### SUMMARY OF THE INVENTION

The present invention aims to provide a toner, which achieves both high durability to folding and high heat resistant storage stability, and has excellent low temperature fixability.

As the means for solving the aforementioned problems, the toner of the present invention include:

As the means for solving the aforementioned problems, the toner of the present invention includes:

a colorant;

a resin; and

a release agent,

wherein M_{THF} is 4.0×10³ to 1.0×10⁶, where M_{THF} is a molecular weight of a peak-top of a peak whose differential molecular distribution value is maximum in a differential molecular weight distribution curve derived from the resin, the differential molecular weight distribution curve being obtained by gel permeation chromatography (GPC) of the toner using tetrahydrofuran (THF) as a solvent, and

wherein there is no peak at a higher molecular weight side of a maximum peak (Pmax) present at a molecular weight of 5×10⁴ or less in a molecular weight distribution derived from the resin, the molecular weight distribution being obtained by GPC of the toner using hexafluoroisopropanol (HFIP) as a solvent, or there are one or more peaks at the higher molecular weight of the Pmax, a total peak area is 35% or less of an area of the Pmax, and the Pmax has a half value width of 3.5×10⁴ or less.

The present invention can provide a toner, which achieves both high durability to folding and high heat resistant storage stability, and has excellent low temperature fixability.

### BRIEF DESCRIPTION OF THE DRAWINGS

FIG. 1A is a diagram illustrating a molecular weight distribution as measured by gel permeation chromatography (GPC) using hexafluoroisopropanol (HFIP) as a solvent, where there is a peak at the higher molecular weight side of a main peak.

FIG. 1B is a diagram illustrating a molecular weight distribution as measured by GPC using HFIP as a solvent, where there is no peak at the higher molecular weight side of a main peak.

FIG. 2A is a diagram illustrating an evaluation method of the maximum peak (Pmax) present at the molecular weight of 5×10⁴ or less in the molecular weight distribution as measured by GPC using HFIP as a solvent.

FIG. 2B is a diagram illustrating an evaluation method of the maximum peak (Pmax) present at the molecular weight of 5×10⁴ or less in the molecular weight distribution as measured by GPC using HFIP as a solvent.

FIG. 3 is a diagram illustrating a method for counting the number of peaks in the molecular weight distribution as measured by GPC using HFIP as a solvent.

FIG. 4 is a diagram illustrating a state where there is no peak at the higher molecular weight side of Pmax in the molecular weight distribution as measured by GPC using HFIP as a solvent, namely a state where n=0.

FIG. 5 is a diagram illustrating a method for determining a difference in the molecular weight between the peak-tops in the molecular weight distribution as measured by GPC using HFIP as a solvent.

FIG. 6 is a diagram illustrating a method for determining the peak area in the molecular weight distribution as measured by GPC using HFIP as a solvent.

FIG. 7 is a diagram illustrating a method for determining a half value width of Pmax in the molecular weight distribution as measured by GPC using HFIP as a solvent.

FIG. 8 is a diagram illustrating a method for determining a half value width of Pmax in the molecular weight distribution as measured by GPC using HFIP as a solvent, when peaks are superimposed.

FIG. 9 is a schematic diagram illustrating one example of a process cartridge for use in the present invention.

FIG. 10 is a schematic configuration diagram illustrating one example of a tandem image forming apparatus.

FIG. 11 is a schematic configuration diagram illustrating another example of a tandem image forming apparatus.

FIG. 12 is a schematic configuration diagram illustrating one example of a tandem image forming apparatus of an indirect transfer system.

FIG. 13 is a schematic configuration diagram illustrating details of a tandem image forming apparatus.

### DETAILED DESCRIPTION OF THE INVENTION

### Toner

The present invention includes at least a colorant, a resin, and a release agent, and may further include other components, if necessary.

As a result of the researches diligently performed by the present inventors to achieve the aforementioned object, they have found that the following toner can achieve both high durability to folding and high heat resistant storage stability, and has excellent low temperature fixability. Namely, the toner is a toner, in which M_{THF} is 4.0×10³ to 1.0×10⁶, where M_{THF} is a molecular weight of a peak-top of a peak whose differential molecular distribution value is maximum in a differential molecular weight distribution curve derived from the resin, the differential molecular weight distribution curve being obtained by gel permeation chromatography (GPC) of the toner using tetrahydrofuran (THF) as a solvent, and in which there is no peak at a higher molecular weight side of a maximum peak (Pmax) present at a molecular weight of 5×10⁴ or less in a molecular weight distribution derived from the resin, the molecular weight distribution being obtained by GPC of the toner using hexafluoroisopropanol (HFIP) as a solvent, or there are one or more peaks at the higher molecular weight of the Pmax, a total peak area is 35% or less of an area of the Pmax, and the Pmax has a half value width of 3.5×10⁴ or less.

The mechanism thereof is currently investigated, but it is assumed as follows based on the several analysis data.

It has been known that a resin of the toner is typically melted at lower temperature, as the molecular weight of the resin is smaller. When the molecular weight (M_{THF}) of a peal top of the maximum peak derived from the resin, which is obtained by GPC using tetrahydrofuran (THF) as a solvent is 4.0×10³ or greater, the toner is not easily melted in the storage environment of the toner, and thus heat resistant storage stability of the toner is excellent. When the M_{THF} is 1.0×10⁶ or less, the toner is sufficiently melted even through the fixing temperature is low, and excellent low temperature fixing ability and durability to folding of the toner is attained.

As for a method for adjusting the M_{THF}, there is a method where the time or temperature of a crosslinking reaction is changed. As the time is longer or the temperature is higher, formation of crosslinks is progressed, and the M_{THF} becomes the lager value.

In order to secure the durability to folding, the toner needs to be sufficiently melted at the degree more than the typical fixing. To this end, it is preferred that a less amount of a high molecular component, which is hardly melted during fixing, is contained. Hexafluoroisopropanol (HFIP) can dissolve the resin of a higher molecular weight region compared to THF. Therefore, a molecular weight distribution of the high molecular weight region, which is associated with durability to folding, can be measured with HFIP.

The part of the toner, which is hardly melted during fixing, is reduced, and excellent durability to folding is attained, when there is no peak at a higher molecular weight side of a maximum peak (Pmax) present at a molecular weight of 5×10⁴ or less in a molecular weight distribution derived from the resin, the molecular weight distribution being obtained by GPC of the toner using hexafluoroisopropanol (HFIP) as a solvent, or there are one or more peaks at the higher molecular weight of the Pmax, a total peak area is 35% or less of an area of the Pmax.

The conventional toners have had a problem, which is a trade-off relationship between durability of a fixed image of the toner to folding, and heat resistant storage stability of the toner. Namely, the heat resistant storage stability is impaired, if the durability to folding is increased, and the durability to folding is impaired, of the heat resistant storage stability is improved. In the present invention, durability of a fixed image of the toner to folding is successfully improved without impairing heat resistant storage stability of the toner, by controlling the peak area at the higher molecular weight side of Pmax to be small with keeping the Pmax.

As for a method for adjusting the area of the peak(s) present at the higher molecular weight side of the Pmax, there is a method where filtration of the resin solution is performed. As the finer the pore of filter paper, large molecules are removed more. Therefore, the area thereof becomes small. Moreover, the peak areas of both sides relative to the higher molecular weight side can be increased by returning part of the filtration cake to the filtrate.

When a half value width of the Pmax is 3.5×10⁴ or less in GPC of the toner, a desirable balance of heat resistant storage stability, low temperature fixability, and durability to folding is attained. The half value width is preferably 2.5×10⁴ or less. In the case where the toner is a toner having the molecular weight distribution where the peak-top molecular weight of the Pmax is small, the toner contains a low molecular weight component that melts at low temperature, if the half value width is greater than 3.5×10⁴. Therefore, such the toner has poor heat resistant storage stability. In the case where the toner is a toner having the molecular weight distribution where the peak-top molecular weight of the Pmax is large, on the other hand, the toner contains a large amount of the high molecular weight component that hardly melts during fixing, if the half value width is greater than 3.5×10⁴. Therefore, such the toner has poor low temperature fixability and low durability to folding.

As for a method for adjusting the half value width of the Pmax, there is a method where an amount of a surfactant added to an aqueous phase is changed. During the emulsification, the low molecular weight component in the resin is withdrawn to the aqueous phase and removed, as an amount of the surfactant is larger. Accordingly, the half value width becomes small.

In the case where there are two or more peaks at the higher molecular weight side of the Pmax in the molecular weight distribution derived from the resin, which is the molecular weight distribution being obtained by GPC of the toner using HFIP as a solvent, a total peak area of the peaks that are second and subsequent peaks counted from the peak closest to the Pmax is preferably 15% or less of the area of the Pmax. As a result of this, the amount of the high molecular weight component that hardly melts during fixing becomes small, leading to excellent low temperature fixability, and excellent durability to folding.

A method for adjusting the area of the peaks present at the high molecular weight side of the Pmax is as mentioned above.

It is preferred that there be only one peak at the higher molecular weight side of the Pmax in the molecular weight distribution derived from the resin, the molecular weight distribution being obtained by GPC using HFIP as a solvent. As a result of this, the amount of the high molecular weight component that hardly melts during fixing becomes small, leading to excellent low temperature fixability, and excellent durability to folding.

A method for adjusting the number of peaks is the same as the method for adjusting the area of the peaks. In order to adjust give only one peak at the higher molecular weight side of the Pmax, there is a method where the filtration cake is further separated, and the separated component is returned to the filtrate.

It is preferred that there be only one peak at the high molecular weight side of the Pmax in the molecular weight distribution derived from the resin, the molecular weight distribution being obtained by GPC using HFIP as a solvent, and a difference in a molecular weight between the Pmax and the only one peak is 8×10⁴ or less. As a result of this, a desired balance of heat resistant storage stability, low temperature fixability, and durability to folding is attained. When the difference in the molecular weight is large, it means that there are peaks in either of both of the low molecular weight region and the high molecular weight region. When the peaks are present in the low molecular weight region that melts at the time of fixing, heat resistant storage stability of the toner is poor. When the peaks are present in the high molecular weight region that hardly melt at the time of fixing, low temperature fixability, and durability to folding of the toner are poor. The case where peaks are present both in the low molecular weight region and the high molecular weight region is not preferable, as all of heat resistant storage stability, low temperature fixability, and durability to folding become poor.

A method for adjusting the toner to have only one peak at the higher molecular weight side of the Pmax is as described above. The molecular weight difference between the Pmax and the only one peak present at the higher molecular weight side of the Pmax can be reduced by returning a smaller molecular weight component to the filterate when the filtration cake is further separated.

A molecular weight (M_{Pmax}) of a peak-top of the Pmax is preferably 5.0×10³ to 2.0×10⁴ in the molecular weight distribution derived from the resin, the molecular weight distribution being obtained by GPC of the toner using HFIP. The aforementioned molecular weight (M_{Pmax}) is preferable, as the resulting toner has an excellent balance between heat resistant storage stability, low temperature fixability, and durability to folding. When the M_{Pmax} is 5.0×10³ or greater, it is preferable because an amount of the low molecular weight component that easily melts under the storage environment of the toner is small, and the toner has excellent heat resistant storage stability. When the M_{Pmax} is 2.0×10⁴ or less, it is preferable because an amount of the high molecular weight component that hardly melt during fixing is small, and the toner has excellent low temperature fixability and durability to folding.

As for a method for adjusting the M_{Pmax}, there is a method where an amount of a crosslinking agent is changed. The larger the amount of the crosslinking agent is, more reaction points there are. Therefore, the number of small molecules becomes small, and the value of the M_{Pmax} becomes large.

### <GPC Using THF and HFIP>

In gel permeation chromatography (GPC), the toner is dissolved in an organic solvent that is identical to a mobile phase, and the insoluble component thereof is removed by filtering, and the soluble component is used for the measurement. Therefore, the obtained molecular weight is information limited to the component soluble to the organic solvent, among the whole toner. In the present invention, GPC using tetrahydrofuran (THF) as a solvent, and GPC using hexafluoroisopropanol (HFIP) as a solvent are discussed. HFIP tends to dissolve the resin more than THF, and thus information of an extremely high molecular weight region can be observed by GPC using HFIP. In order to secure excellent durability to folding without impairing heat resistant storage stability, it is important to control the molecular weight distribution of this molecular weight region. Meanwhile, information disregarding the extremely high molecular weight component of the toner can be attained by GPC using THF. Since a distribution from low molecular weight to slightly high molecular weight can be evaluated without being influenced by the extremely high molecular weight component, a slight difference of this region, which cannot be detected by GPC using HFIP, can be detected. In order to achieve both heat resistant storage stability and low temperature fixability, and both heat resistant storage stability and durability to folding, it is important to control the molecular weight distribution of this region.

—Method for Measuring Molecular Weight Distribution by GPC using THF as Solvent, and for Determining MTHF—

A molecular weight (M_{THF}) of a peak-top of a peak whose differential molecular distribution value was maximum in a differential molecular weight distribution curve derived from the resin obtained by GPC of the toner using tetrahydrofuran (THF) as a solvent in the present invention is preferably evaluated in the following manner.

The evaluation is performed using HLC-8220GPC (column: TSKgel) manufactured by Tosoh Corporation. The toner (6.0 mg) is weighted and collected in a sample tube, followed by adding THF until a total amount thereof becomes 4 g. The resulting mixture is then stirred. When any remaining without being dissolved can be visually observed, the sample tube is placed in an ultrasonic cleaning device for 30 seconds. The sample is left to stand for 24 hours. Then, the supernatant liquid of the sample is suctioned by a syringe by 2 cm³, followed by transferring into a sample cup for a measurement via a chromatodisc (0.45 μm, 25 N, manufactured by KURABO INDUSTRIES LTD.), which is then provided for the measurement.

The measuring conditions are as follows:

Mobile phase: THF

Flow rate: 0.35 mL/min

Temperature: 40° C.

Detector: RI

Sample amount: 10 μL

The data analysis is performed using a calibration curve prepared using standard samples (Shodex STANDARD SM-105, manufactured by SHOWA DENKO K.K.). A molecular weight (M_{THF}) of a peak-top of a peak whose differential molecular distribution value derived from the resin is maximum is calculated from the obtained differential molecular weight distribution curve.

Note that, when the pigment contained in the toner is included in the measuring sample, the pigment may be detected as a peak. However, this peak needs to be disregarded, as it is not peak derived from the resin. As for a method for judging the obtained peak is derived from a resin or pigment, there is a method, in which a pigment per se is measured under the same conditions, and a position of a peak of the pigment is determined. Since the pigment is present in a sample as a large solid insoluble to HFIP, the pigment is eluted at the first stage, without being adsorbed by the column, and often appears as a peak of the largest molecule. Therefore, it is necessary to carefully judge especially when the solution passed through the cromatodisc (0.45 μm, 25 N, manufactured by KURABO INDUSTRIES LTD.) is tinted during the sampling. In the present specification, a peak denotes a part corresponding to a convex portion in the obtained molecular weight distribution.

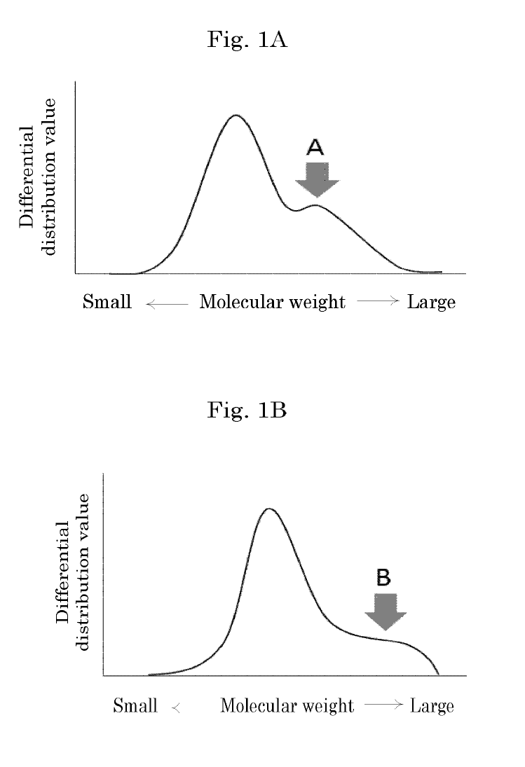

In FIG. 1A, A is regarded as a peak because an increase the differential molecular distribution value is observed again at the higher molecular weight side from the main peak. In FIG. 1A, B is not regarded as a peak because no increase in the differential molecular distribution value is observed at the higher molecular weight side after the main peak, and the differential molecular distribution value is merely gradually decreased. The definition of the peak is the same in the analysis of the molecular weight distribution obtained by GPC using HFIP as a solvent.

—Measurement of Molecular Weight Distribution by GPC using HFIP as Solvent—

A differential molecular weight distribution curve derived from the resin obtained by GPC of the toner using HFIP as a solvent in the present invention is preferably evaluated in the following manner. The evaluation is performed using HLC-8220GPC (column: TSKgel) manufactured by Tosoh Corporation. The toner (6.0 mg) is weighted and collected in a sample tube, followed by adding HFIP until a total amount thereof becomes 4 g. The resulting mixture is then stirred. When any remaining without being dissolved can be visually observed, the sample tube is placed in an ultrasonic cleaning device for 30 seconds. The sample is left to stand for 24 hours. Then, the supernatant liquid of the sample is suctioned by a syringe by 2 cm³, followed by transferring into a sample cup for a measurement via a chromatodisc (0.45 μm, 25 N, manufactured by KURABO INDUSTRIES LTD.), which is then provided for the measurement.

The measuring conditions are as follows.

Mobile phase: HFIP

Flow rate: 0.20 mL/min

Temperature: 40° C.

Detector: RI

Sample amount: 10 μL

The data analysis was performed using a calibration curve prepared using standard samples (EasiCal PM-1 Polymethylmethacrylate Standards, manufactured by Polymer Laboratories). The details are described in the following sections.

Note that, when the pigment contained in the toner is included in the measuring sample, the pigment may be detected as a peak. However, this peak needs to be disregarded, as it is not peak derived from the resin. As for a method for judging the obtained peak is derived from a resin or pigment, there is a method, in which a pigment per se is measured under the same conditions, and a position of a peak of the pigment is determined. Since the pigment is present in a sample as a large solid insoluble to HFIP, the pigment is eluted at the first stage, without being adsorbed by the column, and often appears as a peak of the largest molecule. Therefore, it is necessary to carefully judge especially when the solution passed through the cromatodisc (0.45 μm, 25 N, manufactured by KURABO INDUSTRIES LTD.) is tinted during the sampling.

—Method for determining Pmax and M_{Pmax}—

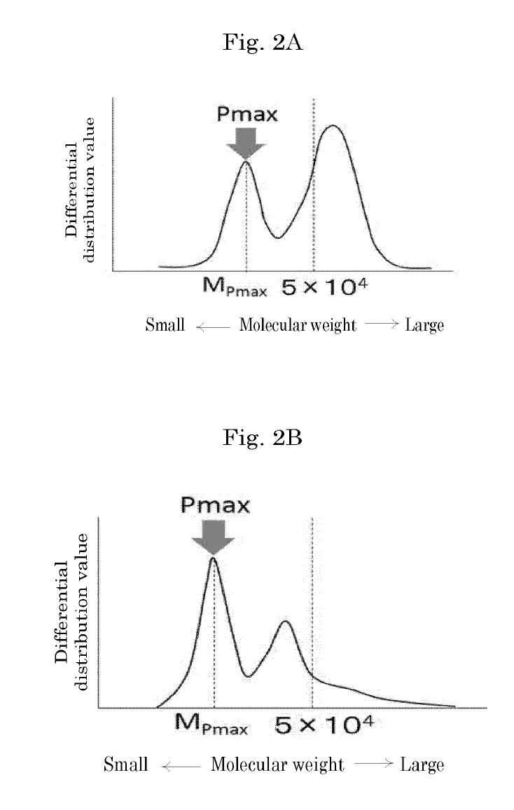

The maximum peak (Pmax) present at the molecular weight of 5×10⁴ or less in the present invention is preferably evaluated in the following method. In the manner as described above, GPC is performed using HFIP as a solvent, and the obtained differential molecular weight distribution curve is analyzed. Among peaks present at the molecular weight of 5×10⁴ or less, the peak whose differential molecular distribution value is the largest is determined as Pmax. Moreover, a molecular weight of a peak-top of the Pmax is determined as M_{Pmax}. Specific examples thereof are presented in FIGS. 2A and 2B.

### —Method for Counting Peaks—

In the present invention, the number of peaks is preferably counted in the following manner. In the manner as described above,

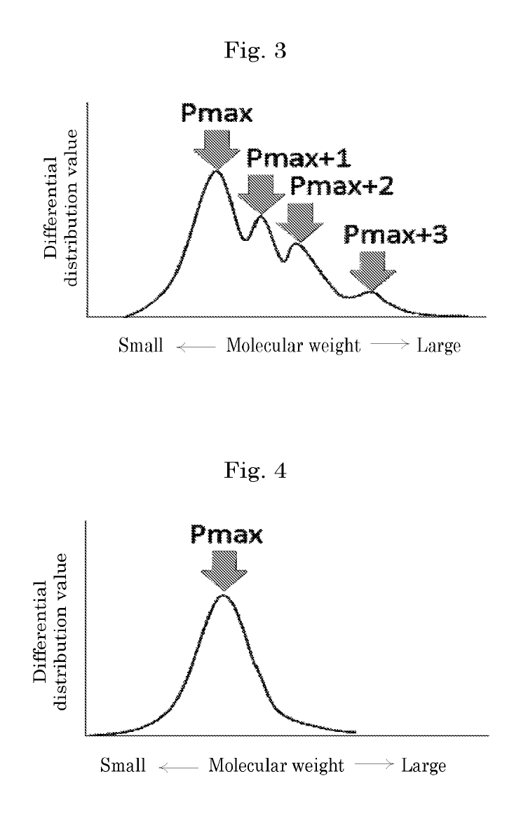

GPC is performed using HFIP as a solvent, and the obtained differential molecular weight distribution curve is analyzed. At first, a position of Pmax is determined by the aforementioned method. The peaks present at the higher molecular weight side of the Pmax are determined as Pmax+1, Pmax+2 . . . Pmax+n from the closest to the furthest to the Pmax (see FIG. 3). A state where there is no peak at the higher molecular weight side of the Pmax denotes a state where n=0 (see FIG. 4). A state where there is only one peak at the higher molecular weight side of the Pmax denotes a state where n=1. A state where there is more than two peaks at the higher molecular weight side of the Pmax denotes a state where n≧2. When the peaks are counted, peaks at the lower molecular weight side of the Pmax are not included.

### —Method for Determining Molecular Weight Difference of Peak-Topes—

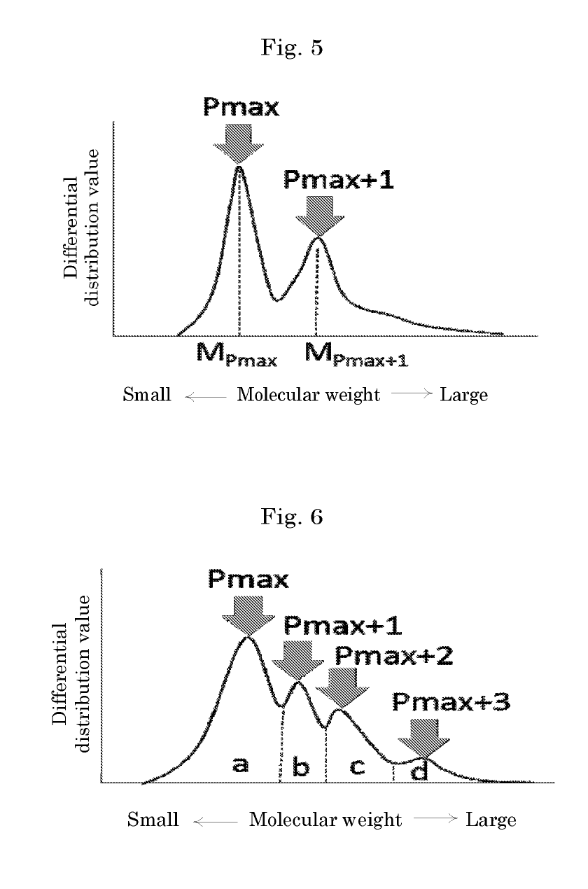

A difference in the molecular weight between the peak-tops in the present invention is preferably measured in the following manner. In the manner as described above, GPC is performed using HFIP as a solvent, and the obtained differential molecular weight distribution curve is analyzed. In the case where there is only one peak at the higher molecular weight side of the Pmax (this peak is determined as Pmax+1), a difference between a molecular weight of the peak-top of the Pmax+1 (determined as M_{Pmax+1}) and M_{Pmax} is determined as the molecular weight difference between the peak-tops (see FIG. 5, and Formula (3)).

Molecular weight difference=M_{Pmax+1}−M_{Pmax} Formula (3)

### —Method for Determining Peak Area—

The peak area in the present invention is preferably determined in the following manner. In the manner as described above, GPC is performed using HFIP as a solvent, and the obtained differential molecular weight distribution curve is analyzed. A vertical line is drawn from each convex present between the peaks (a point at which the differential molecular distribution value becomes the minimum between the peaks) to divide into each peak, and a ratio of the peak area of each peak is calculated. In this process, a base line is drawn horizontally from the elution onset point of the sample.

The peak area of the Pmax is determined as a, the peak area of the Pmax+1 is determined as b, the peak area of the Pmax+2 is determined as c, and the peak area of the Pmax+3 is determined as d, and then calculations are carried out (see FIG. 6). The phrase “In the case where peaks are present at the higher molecular weight side of the Pmax, a total area of the peaks is 35% or less of the area of the Pmax” denotes a state where Formula (1) below is satisfied.

(b+c+d)/a×100≦35 Formula (1)

The phrase “In the case where there are two or more peaks at the higher molecular weight side of the Pmax, a total peak area of the peaks that are second and subsequent peaks counted from the peak closest to the Pmax is 15% or less of the area of the Pmax” denotes a state where Formula (2) below is satisfied.

(c+d)/a×100≦15 Formula (2)

### —Method for Determining Half Value Width of Pmax—

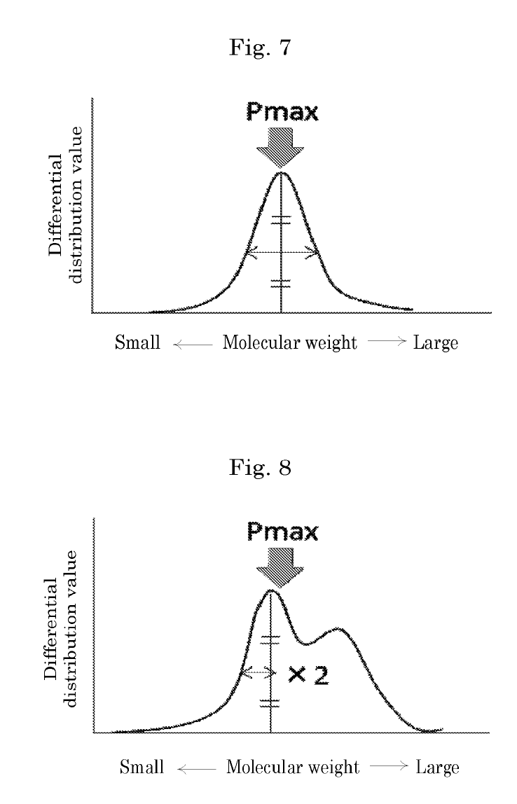

In the present invention, the half value width of the Pmax is preferably evaluated in the following manner. In the manner as described above, GPC is performed using HFIP as a solvent, Pmax is determined from the obtained differential molecular weight distribution curve. The width of the chart (full width at half maximum) at the position where the differential molecular distribution value of the peak-top of the Pmax became a half value is determined as a half value width in the present invention (see FIG. 7). In the case where peaks are superimposed and a full width at half maximum cannot be determined, a value obtained by determining a half width at half maximum, and multiplying the half width at half maximum with 2 is determined as a half value width (see FIG. 8). In the case where peaks are superimposed in the more complex manner, a half value width is determined by performing peak separation through fitting using a least-squares method, followed by determining a width of the chart (full width at half maximum).

### <Resin>

The resin preferably contains a crystalline polyester resin, a non-crystalline polyester resin, a polyester resin (copolymer) containing an amorphous segment and a crystalline segment, or any combination thereof. Among them, the resin is more preferably the polyester resin (copolymer) containing an amorphous segment and a crystalline segment in view of an improvement of low temperature fixability due to finely dispersed crystalline segments.

### <<Crystalline Polyester Resin>>

For example, the crystalline polyester resin is synthesized from a multivalent carboxylic acid component, and a polyhydric alcohol component. Note that, the crystalline polyester resin may be selected from commercial products, or synthesized for use.

Examples of the multivalent carboxylic acid component include: aliphatic dicarboxylic acid, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acid, such as dibasic acid (e.g., phthalic acid, isophthalic acid, terephthalic acid, naphthalene-2,6-dicarboxylic acid, malonic acid, and mesaconic acid). Examples further include anhydrides or lower alkyl ester of the foregoing, but the examples are not limited to the above.

Examples of the trivalent or higher carboxylic acid include 1,2,4-benzenetricarboxylic acid, 1,2,5-benzenetricarboxylic acid, 1,2,4-naphthalenetricarboxylic acid, anhydrides thereof and lower alkyl ester thereof. These may be used alone, or in combination.

Moreover, the acid component may contain, other than the aliphatic dicarboxylic acid or aromatic dicarboxylic acid, a dicarboxylic acid component having a sulfonic acid group. Furthermore, the acid component may contain, other than the aliphatic dicarboxylic acid or aromatic dicarboxylic acid, a dicarboxylic acid component having a double bond.

The polyhydric alcohol component is preferably aliphatic diol, more preferably straight-chain aliphatic diol, whose principle chain segment has 7 to 20 carbon atoms. In the case of branched-chain aliphatic diol, crystallinity of a resulting polyester resin is low, which may lower a melting point thereof. When the number of carbon atoms in the principle chain segment is less than 7, moreover, melting temperature is high in the case where it is condensation polymerized with aromatic dicarboxylic acid, and it may be difficult to achieve low temperature fixability. When the number thereof is greater than 20, it may be difficult to attain a material for practical use. The number of carbon atoms in the principle chain segment is preferably 14 or less. Examples of the aliphatic diol include ethylene glycol, 1,3-propane diol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. These may be used alone, or in combination. Among them, preferred in view of readily availability are 1,8-octanediol, 1,9-nonanediol, and 1,10-decanediol.

Examples of trihydric or higher alcohol include glycerin, trimethylolethane, trimethylolpropane, and pentaerythritol. These may be used alone, or in combination.

An amount of the aliphatic diol in the polyhydric alcohol component is preferably 80 mol % or greater, more preferably 90 mol % or greater. When the amount of the aliphatic diol is less than 80 mol %, crystallinity of the polyester resin may be low, which reduces the melting temperature. Therefore, the blocking resistance of the toner, image storage stability, and low temperature fixability may be degraded.

For the purpose of adjusting an acid value or hydroxyl value, multivalent carboxylic acid or polyhydric alcohol may be optionally added at the final stage of synthesis. Examples of the multivalent carboxylic acid include: aromatic carboxylic acid, such as terephthalic acid, isophthalic acid, phthalic anhydride, trimellitic anhydride, pyromellitic acid, and naphthalene dicarboxylic acid; aliphatic carboxylic acid, such as maleic anhydride, fumaric acid, succinic acid, alkenyl succinic anhydride, adipic acid; and alicyclic carboxylic acid, such as cyclohexane dicarboxylic acid.

Examples of the polyhydric alcohol include: aliphatic diol, such as ethylene glycol, diethylene glycol, triethylene glycol, propylene glycol, butanediol, hexanediol, neopentyl glycol, and glycerin; alicyclic diol, such as cyclohexanediol, cyclohexane dimethanol, and hydrogenated bisphenol A; and aromatic diol, such as bisphenol A ethylene oxide adduct, and bisphenol A propylene oxide adduct.

The term “crystalline polyester resin” means a polymer, 100% by mass of which is composed of a polyester structure, as well as a polymer (copolymer) obtained by copolymerizing a component constituting polyester with another component In the latter case, an amount of another constitutional component, other than polyester, which constituting the polymer (copolymer) is 50% by mass or less.

The production of the crystalline polyester resin can be performed at the polymerization temperature of 180° C. to 230° C. Optionally, the polymerization reaction is carried out with removing water or alcohol generated during condensation by reducing the pressure inside the system.

In the case where polymerizable monomers are not dissolved or do not become compatible at the reaction temperature, the polymerizable monomer may be dissolved by adding a solvent having a high boiling point as a solubilizing agent. The polycondensation reaction is carried out while removing the solubilizing agent. In the case where there is a polymerizable monomer having poor compatibility in the copolymerization reaction, the polymerizable monomer having poor compatibility may be condensed with the polymerizable monomer, and acid or alcohol to be polycondensed in advance, and the resultant may be polycondensed with a main component.

Examples of a catalyst usable in the production of the polyester resin include: an alkali metal compound such as sodium, and lithium; an alkaline earth metal compound such as magnesium, and calcium; a metal compound such as zinc, manganese, antimony, titanium, tin, zirconium, and germanium; and others such as a phosphorous acid compound, a phosphoric acid, and an amine compound.

Specific examples thereof include compounds, such as sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenyl antimony, tributyl antimony, tin formate, tin oxalate, tetraphenyl tin, dibutyl tin dichloride, dibutyl tin oxide, diphenyl tin oxide, zirconium tetrabutoxide, zirconium naphthenate, zirconium carbonate, zirconium acetate, zirconium stearate, zirconium octylate, germanium oxide, triphenyl phosphite, tris(2,4-di-t-butylphenyl)phosphite, ethyltriphenyl phosphonium bromide, triethyl amine, and triphenyl amine.

The melting point of the crystalline polyester resin is preferably 50° C. to 100° C., more preferably 55° C. to 90° C., and even more preferably 55° C. to 85° C. Since the melting point thereof is 50° C. or higher, blocking of a resulting toner does not occur during storage, and storage stability of the toner, and storage stability of a fixed image after fixing become excellent. As the melting point thereof is 100° C. or lower, moreover, sufficient low temperature fixability can be attained.

The melting point of the crystalline polyester resin can be determined as a peak temperature of an endothermic peak obtained by the differential scanning calorimetry (DSC).

The acid value (the value (mg) of KOH necessary to neutralize 1 g of the resin) of the crystalline polyester resin is preferably 3.0 mgKOH/g to 30.0 mgKOH/g, more preferably 6.0 mgKOH/g to 25.0 mgKOH/g, and even more preferably 8.0 mgKOH/g to 20.0 mgKOH/g.

When the acid value is 3.0 mgKOH/g or greater, dispersibility thereof in water is excellent, hence particles can be easily formed by a wet production method. Moreover, stability as polymerized particles is excellent during aggregation, and therefore a toner is efficiently produced. When the acid value thereof is 30.0 mgKOH/g or less, moisture uptake of a resulting toner is appropriate, and excellent environmental stability of the toner can be attained.

The weight average molecular weight (Mw) of the crystalline polyester resin is preferably 6,000 to 35,000. Since the weight average molecular weight (Mw) is 6,000 or greater, a resulting toner is not penetrated into a surface of a recording medium, such as paper, during fixing, hence fixing unevenness is prevented, and moreover, a folding resistance of a fixed image is not reduced. Since the weight average molecular weight (Mw) is 35,000 or less, moreover, the viscosity thereof when melted is not too high, hence the temperature at which the appropriate viscosity for fixing is attained is not high. Accordingly, low temperature fixability is not impaired.

An amount of the crystalline polyester resin in the toner is preferably 10% by mass to 85% by mass. When the amount of the crystalline polyester resin is 10% by mass or greater, excellent low temperature fixability can be attained. When the amount thereof is 85% by mass or less, excellent toner strength or fixed image strength is attained, leading to excellent charging ability.

The aforementioned crystalline resin containing the crystalline polyester resin preferably contains a crystalline polyester resin (may be referred to “crystalline aliphatic polyester resin” hereinafter) synthesized using an aliphatic polymerizable monomer as a main component (50% by mass or greater). In this case, moreover, a proportion of the aliphatic polymerizable monomer constituting the crystalline aliphatic polyester resin is preferably 60 mol % or greater, more preferably 90 mol % or greater. As for the aliphatic polymerizable monomer, the aforementioned aliphatic diol or aliphatic acid can be suitably used.

### <<Non-Crystalline Polyester Resin>>

As for the non-crystalline polyester resin, there are a modified polyester resin, and an unmodified polyester resin.

### —Modified Polyester Resin—

As for the modified polyester resin, for example, a polyester prepolymer containing an isocyanate group can be used.

Examples of the polyester prepolymer containing an isocyanate group (A) includes a product obtained by reacting polyester containing an active hydrogen group, which is a polycondensation product between polyol (1) and polycarboxylic acid (2), with polyisocyanate (3).

Examples of an active hydrogen group contained in the polyester include a hydroxyl group (e.g. an alcoholic hydroxyl group, and a phenolic hydroxyl group), an amino group, a carboxyl group, and a mercapto group. Among them, alcoholic hydroxyl group is preferable.

Examples of the polyol (1) include diol (1-1), and tri or higher polyol (1-2), and the polyol (1) is preferably (1-1) alone, or a mixture of (1-1) with a small amount of (1-2).

Examples of the diol (1-1) include alkylene glycol (e.g., ethylene glycol, 1,2-propylene glycol, 1,3-propylene glycol, 1,4-butanediol, and 1,6-hexanediol); alkylene ether glycol (e.g., diethylene glycol, triethylene glycol, dipropylene glycol, polyethylene glycol, polypropylene glycol, and polytetramethylene ether glycol); alicyclic diol (e.g., 1,4-cyclohexanedimethanol, and hydrogenated bisphenol A); bisphenols (e.g., bisphenol A, bisphenol F, and bisphenol S); alkylene oxide (ethylene oxide, propylene oxide, and butylene oxide) adduct of the alicyclic diol; and alkylene oxide (ethylene oxide, propylene oxide, and butylene oxide) adduct of the bisphenols. Among them, the diol is preferably C2-C12 alkylene glycol, or the alkylene oxide adduct of bisphenols, more preferably the alkylene oxide adduct of bisphenols, or a combination of the alkylene oxide adduct of bisphenols and the C2-C12 alkylene glycol.

Examples of the tri or higher polyol (1-2) include tri- to octa- or higher polyhydric aliphatic alcohol (e.g., glycerin, trimethylol ethane, trimethylol propane, pentaerythritol, and sorbitol), tri or higher phenol (e.g., trisphenol PA, phenol novolak, and cresol novolak); and alkylene oxide adduct of the tri or higher polyphenol.

Examples of the polycarboxylic acid (2) include dicarboxylic acid (2-1), and tri- or higher polycarboxylic acid (2-2). The polycarboxylic acid (2) is preferably (2-1) alone, or a mixture of (2-1) with a small amount of (2-2).

Examples of the dicarboxylic acid (2-1) include alkylene dicarboxylic acid (e.g., succinic acid, adipic acid, and sebacic acid), alkyenylene dicarboxylic acid (e.g., maleic acid, and fumaric acid), and aromatic dicarboxylic acid (e.g., phthalic acid, isophthalic acid, terephthalic acid, and naphthalene dicarboxylic acid). Among them, preferred are C4-C20 alkenylene dicarboxylic acid, and C8-C20 aromatic dicarboxylic acid.

Examples of the tri or higher polycarboxylic acid (2-2) include C9-C20 aromatic polycarboxylic acid (e.g., trimellitic acid, and pyromellitic acid). Note that, as for the polycarboxylic acid (2), acid anhydride or lower alkyl ester (e.g., methyl ester, ethyl ester, and isopropyl ester) of the above-listed polycarboxylic acid may be reacted with polyol (1).

A ratio of the polyol (1) to the polycarboxylic acid (2) is determined as an equivalent ratio [OH]/[COOH] of hydroxyl groups [OH] to carboxyl groups [COOH], which is preferably 2/1 to 1/1, more preferably 1.5/1 to 1/1, and even more preferably 1.3/1 to 1.02/1.

Examples of the polyisocyanate (3) include aliphatic polyisocyanate (e.g., tetramethylene diisocyanate, hexamethylene diisocyanate, and 2,6-diisocyanate methyl caproate), alicyclic polyisocyanate (e.g., isophorone diisocyanate, and cyclohexylmethane diisocyanate), aromatic diisocyanate (e.g., tolylene diisocyanate, and diphenyl methane diisocyanate), aromatic aliphatic diisocyanate (e.g., α,α,α′,α′-tetramethyl xylylene diisocyanat), isocyanurates, phenol derivatives of the polyisocyanate, the foregoing polyisocyanates blocked with oxime or caprolactam, and any combination of the foregoing polyisocyanates.

A ratio of the polyisocyanate (3) is determined as an equivalent ratio [NCO]/[OH] of isocyanate groups [NCO] to hydroxyl groups [OH] of the polyester having a hydroxyl group, which is preferably 5/1 to 1/1, more preferably 4/1 to 1.2/1, and even more preferably 2.5/1 to 1.5/1. When the ratio [NCO]/[OH] is 5 or greater, excellent low temperature fixability can be attained. When the molar ratio of [NCO] is 1 or greater, an appropriate urea content of the modified polyester can be attained, hence excellent hot offset resistance is attained.

An amount of the polyisocyanate (3) constituting component in the prepolymer containing an isocyanate group at a terminal thereof (A) is preferably 0.5% by mass to 40% by mass, more preferably 1% by mass to 30% by mass, and more preferably 2% by mass to 20% by mass. When the amount thereof is 0.5% by mass or greater, excellent hot offset resistance is attained, and both heat resistant storage stability and low temperature fixing ability are achieved. When the amount thereof is 40% by mass or less, excellent low temperature fixability is attained.

The number of isocyanate groups per molecule of the prepolymer containing an isocyanate group (A) is preferably 1 or more, more preferably 1.5 to 3 on average, and even more preferably 1.8 to 2.5 on average. When the number thereof per molecule is 1 or more, an appropriately molecular weight of modified polyester is attained after crosslinking and/or elongation, and excellent hot offset resistance is attained.

Moreover, amines can be optionally used as a curing agent and/or an elongation agent.

Examples of the amines (B) include diamine (B1), tri- or higher polyamine (B2), amino alcohol (B3), aminomercaptan (B4), amino acid (B5), and a blocked compound (B6) where an amino group of any of the foregoing B1 to B5 is blocked.

Examples of the diamine (B1) include aromatic diamine (e.g., phenylenediamine, diethyl toluene diamine, and 4,4′-diaminodiphenylmethane), alicyclic diamine (e.g., 4,4′-diamino-3,3′-dimethyldicyclohexylmethane, diamin ecyclohexane, and isophorone diamine), and aliphatic diamine (e.g., ethylene diamine, tetramethylene diamine, and hexamethylene diamine).

Examples of the tri- or higher polyamine (B2) include diethylene triamine, and triethylene tetramine.

Examples of the amino alcohol (B3) include ethanol amine, and hydroxyethyl aniline.

Examples of the aminomercaptan (B4) include aminoethylmercaptan, and aminopropylmercaptan.

Examples of the amino acid (B5) include amino propionic acid, and amino caproic acid.

Examples of the blocked compound (B6) where an amino group of any of the foregoing B1 to B5 include a ketimine compound and oxazoline compound obtained from the amines of (B1) to (B5) and ketones (e.g., acetone, methyl ethyl ketone and methyl isobutyl ketone).

Among these amines (B), preferred are B1, and a mixture of B1 with a small amount of B2.

Moreover, a terminator is optionally used for the crosslink and/or elongation to adjust a molecular weight of modified polyester after the reaction.

Examples of the terminator include: monoamine (e.g., diethyl amine, dibutyl amine, butyl amine, and lauryl amine), and a blocked product thereof (e.g., a ketimine compound).

A ratio of the amines (B) is determined as an equivalent ratio [NCO]/[NHx] of isocyanate groups [NCO] in the prepolymer having an isocyanate group (A) to amino groups [NHx] in the amines (B), which is typically 1/2 to 2/1, preferably 1.5/1 to 1/1.5, and more preferably 1.2/1 to 1/1.2. When the ratio [NCO]/[NHx] is in the range of 1/2 to 2/1, an appropriate molecular weight of urea-modified polyester (i) is attained, and excellent hot offset resistance is attained.

### —Unmodified Polyester Resin—

The unmodified polyester is a polyester resin obtained with polyhydric alcohol, and multivalent carboxylic acid or a derivative thereof (e.g., multivalent carboxylic acid, multivalent carboxylic acid anhydride, and multivalent carboxylic acid ester), and a polyester resin that is not modified with an isocyanate compound.

Examples of the polyhydric alcohol include Examples of the diol include: bisphenol A (C2-C3) alkylene oxide (the average number of moles added: 1 to 10) adducts, such as polyoxypropylene(2.2)-2,2-bis(4-hydroxyphenyl)propane, and polyoxyethylene(2.2)-2,2-bis(4-hydroxyphenyl)propane; ethylene glycol, propylene glycol; and hydrogenated bisphenol A, and hydrogenated bisphenol A (C2-C3) oxide (the average number of moles added: 1 to 10) adducts. These may be used alone, or in combination.

Examples of the multivalent carboxylic acid include dicarboxylic acid.

Examples of the dicarboxylic acid include adipic acid, phthalic acid, isophthalic acid, terephthalic acid, fumaric acid, maleic acid, and succinic acid substituted with C1-C20 alkyl group or C2-C20 alkenyl group (e.g., dodecenyl succinic acid, and octyl succinic acid). These may be used alone, or in combination.

The unmodified polyester may contain trivalent or higher carboxylic acid, or trihydric or higher alcohol, or both at a terminal of the resin chain thereof, for the purpose of adjusting an acid value or hydroxyl value thereof.

Examples of the trivalent or higher carboxylic acid include trimellitic acid, pyromellitic acid, and anhydrides thereof.

Examples of the trihydric or higher alcohol include glycerin, pentaerythritol, and trimethylolpropane.

The molecular weight of the unmodified polyester is appropriately selected depending on the intended purpose without any limitation. When the molecular weight thereof is too small, however, the toner may have poor heat resistant storage stability, and poor resistance to stress caused by stirring inside a developing device. When the molecular weight is too large, the viscoelasticity of the toner when melted is high, which may lead to poor low temperature fixability. As for the molecular weight, therefore the weight average molecular weight (Mw) as measured by gel permeation chromatography (GPC) is preferably 3,000 to 10,000. Moreover, the number average molecular weight (Mn) is preferably 1,000 to 4,000. Furthermore, the ratio Mw/Mn is preferably 1.0 to 4.0.

The weight average molecular weight (Mw) is more preferably 4,000 to 7,000. The number average molecular weight (Mn) is more preferably 1,500 to 3,000. The ratio Mw/Mn is more preferably 1.0 to 3.5.

The acid value of the unmodified polyester is appropriately selected depending on the intended purpose without any limitation, but the acid value thereof is preferably 1 mgKOH/g to 50 mgKOH/g, more preferably 5 mgKOH/g to 30 mgKOH/g. As the acid value thereof is 1 mgKOH/g or greater, a resulting toner tends to be negatively charged, which improves compatibility with paper during fixing to the paper. As a result, low temperature fixability is improved. As the acid value is 50 mgKOH/g or less, charging stability, particularly charging stability to environmental changes, is excellent.

The hydroxyl value of the unmodified polyester is appropriately selected depending on the intended purpose without any limitation, but the hydroxyl value thereof is preferably 5 mgKOH/g or greater.

The glass transition temperature (Tg) of the unmodified polyester is appropriately selected depending on the intended purpose without any limitation, but the glass transition temperature (Tg) thereof is preferably 40° C. to 70° C.

The molecular structure of the unmodified polyester can be confirmed by solution or solid NMR spectroscopy, X-ray diffraction spectroscopy, GC/MS, LC/MS, or IR spectroscopy. As for a simple method thereof, there is a method where a compound giving an infrared absorption spectrum having no absorption based on δCH (out plane bending) of olefin at 965±10 cm⁻¹ and 990±10 cm⁻¹ is detected as a noncrystalline polyester.

### <<Polyester Resin (Copolymer) Containing Amorphous Segment and Crystalline Segment>>

The polyester resin (copolymer) containing an amorphous segment and a crystalline segment is appropriately selected depending on the intended purpose without any limitation, provided that it contains a crystalline segment and an amorphous segment per molecule. Examples thereof include: a copolymer composed of repeating units derived from a crystalline monomer, and repeating units derived from an amorphous monomer; a copolymer composed of repeating units derived from a crystalline oligomer, and repeating units derived from an amorphous oligomer; a copolymer composed of repeating units derived from a crystalline polymer, and repeating units derived from an amorphous polymer; and a combination thereof. Among them, particularly preferred is a copolymer composed of repeating units derived from a crystalline polymer, and repeating units derived from an amorphous polymer.

A state of copolymerization of the copolymer is appropriately selected depending on the intended purpose without any limitation, but preferred is a block copolymer.

Examples of a crystalline polymer used in the repeating unit derived from a crystalline polymer include the crystalline resin.

Examples of an amorphous polymer used in the repeating unit derived from an amorphous polymer include the non-crystalline resin.

A method of the copolymerization is appropriately selected depending on the intended purpose without any limitation, and examples thereof include the following methods (1) to (3).

(1) A method, in which an amorphous resin, which has been prepared by a polymerization reaction in advance, and a crystalline resin, which has been prepared by a polymerization reaction in advance, are dissolved and/or dispersed in an appropriate solvent, and the amorphous resin and the crystalline resin are allowed to react with an elongation agent containing two or more functional groups (e.g., an isocyanate group, and epoxy group) capable of reacting with a hydroxyl group or carboxylic acid present at the terminal of the polymer chain to thereby copolymerize the amorphous resin and the crystalline resin.
(2) A method where an amorphous resin, which is prepared by a polymerization reaction in advance, and a crystalline resin, which is prepared by a polymerization reaction in advance, are melt-kneaded, and are allowed to go through transesterification under the reduced pressure, to thereby prepare a copolymer.
(3) A method where hydroxyl groups of a crystalline resin, which has been prepared by a polymerization reaction in advance, are used as a polymerization initiation component, and an amorphous resin is copolymerized through ring-opening polymerization from a terminal of the polymer chain of the crystalline resin.

### —Crystalline Segment—

The crystalline segment preferably has a common skeleton to the crystalline resin, which is composed of the same monomer unit to that of the crystalline resin, as the affinity (compatibility) between the crystalline resin and the copolymer is improved, and a resulting toner has excellent heat resistant storage stability, and low temperature fixability.

As for the skeleton of the crystalline segment composed of the monomer unit, the same skeleton to that of the crystalline resin can be used. Aliphatic polyester is particularly preferable as the skeleton. The aliphatic polyester is appropriately selected from those used for the crystalline resin.

### —Amorphous Segment—

The amorphous segment preferably has a common skeleton to the non-crystalline resin, which is composed of the same monomer unit to that of the non-crystalline resin, as the affinity (compatibility) between the non-crystalline resin and the copolymer is improved, and a resulting toner has excellent heat resistant storage stability and low temperature fixability.

As for the skeleton of the amorphous segment composed of the monomer unit, the same skeleton to that of the non-crystalline resin can be used.

### <Colorant>

The colorant is appropriately selected depending on the intended purpose without any limitation, and examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine GB, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used alone, or in combination.

An amount of the colorant is appropriately selected depending on the intended purpose without any limitation, but the amount thereof is preferably 1 part by mass to 15 parts by mass, more preferably 3 parts by mass to 10 parts by mass, relative to 100 parts by mass of the toner.

The colorant may be used as a master batch, in which the colorant forms a composite with a resin. Examples of the resin used for production of the master batch, or kneaded together with the master batch include, other than the polyester resin: a polymer of styrene or a derivative thereof, such as polystyrene, poly(p-chlorostyrene), and polyvinyl toluene; a styrene-based copolymer, such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleic acid ester copolymer; and others, such as polymethyl methacrylate, polybutyl methacrylate, polyvinyl chloride, polyvinyl acetate, polyethylene, polypropylene, polyester, an epoxy resin, an epoxy polyol resin, polyurethane, polyamide, polyvinyl butyral, a polyacrylic acid resin, rosin, modified rosin, a terpene resin, an aliphatic or alicyclic hydrocarbon resin, an aromatic petroleum resin, chlorination paraffin, and paraffin wax. These may be used alone, or in combination.

The master batch can be obtained by mixing the resin for a master batch and the colorant together through application of high shearing force, followed by kneading the mixture. In order to enhance the interactions between the colorant and the resin during the mixing and kneading, an organic solvent may be used. Moreover, a so-called flashing method is preferably used, since a wet cake of the colorant can be directly used without being dried. The flashing method is a method in which an aqueous paste containing a colorant is mixed or kneaded with a resin and an organic solvent, and then the colorant is transferred to the resin to remove the moisture and the organic solvent. As for the mixing and kneading, a high-shearing disperser (e.g., a three-roll mill) is preferably used.

### <Release Agent>

The release agent is appropriately selected depending on the intended purpose without any limitation, but the release agent is preferably wax.

The wax is appropriately selected depending on the intended purpose without any limitation, and examples thereof include: polyolefin wax (e.g., polyethylene wax, and polypropylene wax); ling-chain hydrocarbon (e.g., paraffin wax, and Sasol wax); and carbonyl group-containing wax. These may be used alone, or in combination. Among them, preferred is carbonyl group-containing wax.

Examples of the carbonyl group-containing wax include: polyalkanoic acid ester, polyalkanol ester, polyalkanoic acid amide, polyalknyl amide, and dialkyl ketone.

Examples of the polyalkanoic acid ester include carnauba wax, montan wax, trimethylol propane tribehenate, pentaerythritol tetrabehenate, pentaerythritol diacetate dibehenate, glycerin tribehenate, and 1,18-octadecanediol distearate.

Examples of the polyalkanol ester include tristearyl trimellitate, and distearyl maleate.

Examples of the polyalkanoic acid amide include ethylene diamine dibehenyl amide.

Examples of the polyalkyl amide include trimellitic acid tristearyl amide.

Examples of the dialkyl ketone include distearyl ketone. Among them, polyalkanoic acid ester is preferable as the carbonyl group-containing wax.

The melting point of the wax is preferably 40° C. to 160° C., more preferably 50° C. to 120° C., and even more preferably 60° C. to 90° C. When the melting point thereof is 40° C. or higher, heat resistant storage stability of a resulting toner is excellent. When the melting point thereof is 160° C. or lower, cold offset of a resulting toner does not occur, when fixed at low temperature.

Moreover, the melt viscosity of the wax as measured at the temperature higher than the melting point of the wax by 20° C. is preferably 5 cps to 1,000 cps, more preferably 10 cps to 100 cps. As the melt viscosity is 1,000 cps or less, effects of improving hot offset resistance, and low temperature fixability can be attained.

An amount of the release agent is appropriately selected depending on the intended purpose without any limitation, but the amount thereof is preferably 2 parts by mass to 10 parts by mass, more preferably 3 parts by mass to 8 parts by mass, relative to 100 parts by mass of the toner. When the amount thereof is 2 parts by mass or greater, excellent low temperature fixability is attained. When the amount thereof is 10 parts by mass or less, excellent heat resistant storage stability is attained, and image fogging is prevented. When the amount thereof is within the aforementioned more preferable range, it is advantageous because image quality and fixing stability are further improved.

### <Other Components>

Examples of the aforementioned other components include a charge controlling agent, external additives, a flowability improving agent, a cleaning improving agent, and a magnetic material.

### —Charge Controlling Agent—

The charge controlling agent is appropriately selected depending on the intended purpose without any limitation, and examples thereof include a nigrosine dye, a triphenylmethane dye, a chrome-containing metal complex dye, a molybdic acid chelate pigment, a rhodamine dye, alkoxy amine, a quaternary ammonium salt (including fluorine-modified quaternary ammonium salt), alkylamide, phosphorus or a compound thereof, tungsten or a compound thereof, a fluorosurfactant, a metal salt of salicylic acid, and a metal salt of a salicylic acid derivative.

Specific examples of the charge controlling agent include: nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); LRA-901, and boron complex LR-147 (manufactured by Japan Carlit Co., Ltd.); copper phthalocyanine; perylene; quinacridone; azo pigments; and polymeric compounds having, as a functional group, a sulfonic acid group, carboxyl group, and quaternary ammonium salt.

An amount of the charge controlling agent is appropriately selected depending on the intended purpose without any limitation, but the amount thereof is preferably 0.1 parts by mass to 10 parts by mass, more preferably 0.2 parts by mass to 5 parts by mass, relative to 100 parts by mass of the toner. When the amount thereof is 10 parts by mass or less, appropriate charging ability of the toner is attained, and an effect as a main charge controlling agent can be attained. Moreover, an electrostatic suction force with a developing roller become appropriately, which may cause low flowability of the developer or low image density. The charge controlling agent may be melt-kneaded with a master batch or resin, followed by dissolving and dispersing in an organic solvent. Alternatively, the charge controlling agent may be directly added when other materials are dissolved and dispersed, or may be deposited and fixed on surfaces of toner particles, after producing the toner particles.

### —External Additives—

As for the external additives, other than oxide particles, inorganic particles or hydrophobic inorganic particles are used in combination. Preferred are hydrophobic inorganic particles having the average primary particle diameter of 1 nm to 100 nm, more preferably 5 nm to 70 nm.

Moreover, the preferable external additives are external additives containing at least one type of hydrophobic inorganic particles having the average primary particle diameter of 20 nm or smaller, and at least one hydrophobic inorganic particles having the average primary particle diameter of 30 nm or greater. Moreover, the BET specific surface area thereof is preferably 20 m²/g to 500 m²/g.

The external additives are appropriately selected depending on the intended purpose without any limitation, and examples thereof include silica particles, hydrophobic silica, fatty acid metal salt (e.g., zinc stearate, and aluminum stearate), metal oxide (e.g., titania, alumina, tin oxide, and antimony oxide), and a fluoropolymer.

Examples of the preferable additives include hydrophobic silica, titania, titanium oxide, and alumina particles. Examples of the silica particles include R972, R974, RX200, RY200, R202, R805, and R812 (all manufactured by Nippon Aerosil Co., Ltd.). Examples of the titania particles include: P-25 (manufactured by Nippon Aerosil Co., Ltd.); STT-30, and STT-65C-S (both manufactured by Titan Kogyo, Ltd.); TAF-140 (manufactured by Fuji Titanium Industry Co., Ltd.); and MT-150 W, MT-500B, MT-600B, and MT-150A (all manufactured by TAYCA CORPORATION).

Examples of the hydrophobic titanium oxide particles include: T-805 (manufactured by Nippon Aerosil Co., Ltd.); STT-30A, STT-65S-S (both manufactured by Titan Kogyo, Ltd.); TAF-500T, TAF-1500T (both manufactured by Fuji Titanium Industry Co., Ltd.); MT-100S, MT-100T (both manufactured by TAYCA CORPORATION); and IT-S (manufactured by ISHIHARA SANGYO KAISHA, LTD.).

For example, hydrophobic oxide particles, hydrophobic silica particles, hydrophobic titania particles, and hydrophobic alumina particles can be obtained by treating hydrophilic particles with a silane coupling agent, such as methyltrimethoxysilane, methyltriethoxysilane, and octyltrimethoxysilane. Moreover, silicone oil-treated oxide particles, or silicone oil-treated inorganic particles, in which oxide or inorganic particles are treated with silicone oil, optionally upon application of heat, is preferable.

Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and α-methylstyrene-modified silicone oil.

Examples of the inorganic particles include silica, titanium oxide, barium titanate, magnesium titanate, calcium titanate, strontium titanate, iron oxide, copper oxide, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. Among them, silica and titanium dioxide are particularly preferable.

An amount of the external additives is appropriately selected depending on the intended purpose without any limitation, but the amount thereof is preferably 0.1 parts by mass to 5 parts by mass, more preferably 0.3 parts by mass to 3 parts by mass, relative to 100 parts by mass of the toner.

The average particle diameter of the primary particles of the inorganic particles is appropriately selected depending on the intended purpose without any limitation, but the average particle diameter thereof is preferably 100 nm or smaller, more preferably 3 nm to 70 nm. When the average particle diameter is smaller than the aforementioned range, the inorganic particles are embedded in the toner base particles, and it is difficult to exhibit the effect of the inorganic particles. When the average particle diameter is larger than the aforementioned range, it is not preferable, because the inorganic particles may unevenly damage a surface of a photoconductor.

### —Flowability Improving Agent—

The flowability improving agent is appropriately selected depending on the intended purpose without any limitation, provided that it is an agent used to perform a surface treatment to increase hydrophobicity, to thereby prevent degradations of flowability and charging properties of the toner in high humidity environments. Examples thereof include a silane coupling agent, a sililation agent, a silane-coupling agent containing a fluoroalkyl group, an organic titanate-based coupling agent, an aluminum-based coupling agent, silicone oil, and modified-silicone oil. It is particularly preferred that the silica and the titanium oxide be surface-treated with the aforementioned flowability improving agent, and used as hydrophobic silica, and hydrophobic titanium oxide.

### —Cleaning Improving Agent—

The cleaning improving agent is appropriately selected depending on the intended purpose without any limitation, provided that it is an agent added to the toner in order to remove a developer remained on a photoconductor or primary transfer member after transferring. Examples of the cleaning improving agent include fatty acid (e.g. stearic acid) metal salt (e.g., zinc stearate, and calcium stearate), and polymer particles produced by soap-free emulsification polymerization, such as polymethyl methacrylate particles, and polystyrene particles. The polymer particles preferably have a relatively narrow particle size distribution, and the volume average particle diameter thereof is preferably 0.01 μm to 1 μm.

### —Magnetic Material—

The magnetic material is appropriately selected depending on the intended purpose without any limitation, and examples thereof include an iron powder, magnetite, and ferrite. Among them, a white magnetic material is preferable in view of a color tone.

### <Production Method of Toner>

A production method of the toner is appropriately selected depending on the intended purpose without any limitation. The toner is preferably granulated by dispersing, in an aqueous medium, an oil phase, which contains a crystalline polyester resin, a non-crystalline polyester resin, or a polyester resin (copolymer) containing an amorphous segment and a crystalline segment, or any combination thereof as a resin, and contains the release agent, the colorant, and optional other components.

One example of the aforementioned production method of the toner include a conventional solution suspension method. In this method, preparation of an aqueous medium, preparation of an oil phase containing a toner material, emulsification and/or dispersion of the toner material, and removal of an organic solvent are performed.

—Preparation of Aqueous Medium (Aqueous phase)—

For example, the preparation of the aqueous medium can be performed by dispersing resin particles in an aqueous medium. An amount of the resin particles added to the aqueous medium is appropriately selected depending on the intended purpose without any limitation, but the amount thereof is preferably 0.5 parts by mass to 10 parts by mass, relative to 100 parts by mass of the aqueous medium.

The aqueous medium is appropriately selected depending on the intended purpose without any limitation, and examples thereof include water, a solvent miscible with water, and a mixture thereof. These may be used alone, or in combination. Among them, water is preferable.

### —Resin Particles—

The resin particles has the glass transition temperature (Tg) of 40° C. to 100° C., more preferably has the weight average molecular weight of 3,000 to 300,000. When the glass transition temperature (Tg) is lower than 40° C., and/or the weight average molecular weight is smaller than 3,000, as described earlier, a toner has poor storage stability, and blocking may occur during the storage of the toner, or inside a developing device. When the glass transition temperature (Tg) is higher than 100° C., and/or the weight average molecular weight is greater than 300,000, the resin particles may impair the adhesion with fixing paper, elevating the minimum fixing temperature.

It is more preferred that the residual rate of the resin particles on toner particles be 0.5% by mass to 5.0% by mass. When the residual rate thereof is less than 0.5% by mass, storage stability of a resulting toner is poor, which may cause blocking during storage, or inside a developing device. When the residual rate thereof is greater than 5.0% by mass, on the other hand, the resin particles impair bleeding of the wax, hence a releasing effect of the wax cannot be attained and offset may occur.

The residual rate of the resin particles can be measured by analyzing a material, which is not derived from the toner particles, but is derived from the resin particles, by GC-MS, and calculating from the peak area thereof. As for a detector, a mass spectrometer is preferable, but the detector is not particularly limited.

As for resin particles, any resin can be used as long as it is a resin that can form aqueous dispersed elements. The resin may be a thermoplastic resin, or a thermoset resin, Examples thereof include a vinyl-based resin, a polylactic acid resin, a polyurethane resin, an epoxy resin, a polyester resin, a polyamide resin, a polyimide resin, a silicon-based resin, a phenol resin, a melamine resin, a urea resin, an aniline resin, an iomer resin, and a polycarbonate resin. As for the resin particles, two or more resins selected from the above-listed resins may be used. Among them, preferred are a vinyl-based resin, a polyurethane resin, an epoxy resin, a polyester resin, and combinations thereof, as an aqueous dispersion of fine spherical resin particles can be easily attained.

The vinyl-based resin is a polymer obtained by homopolymerizing or copolymerizing a vinyl-based monomer. Examples thereof include a styrene-(meth)acrylate resin, a styrene-butadiene copolymer, a (meth)acrylic acid-acrylate polymer, a styrene-acrylonitrile copolymer, a styrene-maleic anhydride copolymer, and a styrene-(meth)acrylic acid copolymer.

The solvent miscible with water is appropriately selected depending on the intended purpose without any limitation, and examples thereof include alcohol, dimethylformamide, tetrahydrofuran, cellsolves, and lower ketone. The alcohol is appropriately selected depending on the intended purpose without any limitation, and examples thereof include methanol, isopropanol, and ethylene glycol. The lower ketone is appropriately selected depending on the intended purpose without any limitation, and example thereof include acetone, and methyl ethyl ketone.

### —Preparation of Oil Phase—

The preparation of the oil phase containing the toner material can be performed by dissolving and/or dispersing, in an organic solvent, a toner material, which contains a crystalline polyester resin, a non-crystalline polyester resin, or a polyester resin (copolymer) containing an amorphous segment and a crystalline segment, or any combination thereof, and optionally further contains the release agent, and the colorant.

The organic solvent is appropriately selected depending on the intended purpose without any limitation, but it is preferably an organic solvent having a boiling point lower than 150° C. in view of easiness of removal thereof.

The organic solvent having a boiling point lower than 150° C. is appropriately selected depending on the intended purpose without any limitation, and examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethylketone, and methyl isobutyl ketone. These may be used alone, or in combination.

Among them, ethyl acetate, toluene, xylene, benzene, methylene chloride, 1,2-dichloroethane, chloroform, and carbon tetrachloride are preferable, and ethyl acetate is more preferable.

—Emulsification and/or Dispersion—

The emulsification and/or dispersion of the toner material can be performed by dispersing the oil phase containing the toner material in the aqueous medium. When the toner material is emulsified and/or dispersed, the curing agent and the prepolymaer are allowed to react through an elongation reaction and/or a cross-linking reaction. The reaction conditions (reaction time, reaction temperature) for generating the prepolymer are appropriately selected depending on a combination of the curing agent and the prep olymer, without any limitation.

The reaction time is appropriately selected depending on the intended purpose without any limitation, but the reaction time is preferably 10 minutes to 40 hours, more preferably 2 hours to 24 hours.

The reaction temperature is appropriately selected depending on the intended purpose without any limitation, but the reaction temperature is preferably 0° C. to 150° C., more preferably 40° C. to 98° C.

A method for stably forming a dispersion liquid containing the prepolymer in the aqueous medium is appropriately selected depending on the intended purpose without any limitation, and examples thereof include a method, in which the oil phase prepared by dissolving or dispersing the toner material in the solvent is added to the aqueous medium phase, and the mixture is dispersed by shearing force.

A dispersing device used for the dispersing is appropriately selected depending on the intended purpose without any limitation, and examples thereof include a low-speed shearing disperser, a high-speed shearing disperser, a friction disperser, a high-pressure jet disperser, and an ultrasonic disperser.

Among them, a high-speed shearing disperser is preferable, as particle diameters of dispersed elements (oil droplets) can be controlled in the range of 2 μm to 20 μm.

In the case where the high-speed shearing disperser is used, the conditions thereof, such as the rotational speed, dispersion time, and dispersion temperature, are appropriately selected depending on the intended purpose.

The rotational speed is appropriately selected depending on the intended purpose without any limitation, but the rotational speed thereof is preferably 1,000 rpm to 30,000 rpm, more preferably 5,000 rpm to 20,000 rpm.

The dispersion time is appropriately selected depending on the intended purpose without any limitation. In case of a batch system, the dispersion time is preferably 0.1 minutes to 5 minutes.

The dispersion temperature is appropriately selected depending on the intended purpose without any limitation, but the dispersion temperature is preferably 0° C. to 150° C., more preferably 40° C. to 98° C. under the pressure. Note that, dispersing is typically easily performed when the dispersion temperature is high.

An amount of the aqueous medium used when the toner material is emulsified and/or dispersed is appropriately selected depending on the intended purpose without any limitation, but the amount thereof is preferably 50 parts by mass to 2,000 parts by mass, more preferably 100 parts by mass to 1,000 parts by mass, relative to 100 parts by mass of the toner material.

When the amount of the aqueous medium is less than 50 parts by mass, a dispersed state of the toner material is poor, so that toner base particles of the predetermined particle diameters may not be attained. When the amount thereof is greater than 2,000 parts by mass, the production cost becomes high.

When the oil phase containing the toner material is emulsified and/or dispersed, a dispersing agent is preferably used for the purpose of making a particle size distribution thereof sharp, as well as attaining desired shapes.

The dispersing agent is appropriately selected depending on the intended purpose without any limitation, and examples thereof include a surfactant, a water-insoluble inorganic compound dispersing agent, a polymer protective colloid. These may be used alone, or in combination. Among them, a surfactant is preferable.

The surfactant is appropriately selected depending on the intended purpose without any limitation, and examples thereof include an anionic surfactant, a cationic surfactant, a nonionic surfactant, and an amphoteric surfactant.

Examples of the anionic surfactant include alkyl benzene sulfonic acid salts, α-olefin sulfonic acid salts, phosphoric acid esters, and an anionic surfactant containing a fluoroalkyl group. Among them, an anionic surfactant containing a fluoroalkyl group is preferable. Examples of the anionic surfactant containing a fluoroalkyl group include C2-C10 fluoroalkyl carboxylic acid or a metal salt thereof, disodium perfluorooctane sulfonyl glutamate, sodium 3-[ω-fluoroalkyl(C6-C11)oxy)-1-alkyl(C3-C4) sulfonate, sodium 3-[ω-fluoroalkanoyl(C6-C8)-N-ethylamino]-1-propanesulfonate, fluoroalkyl(C11-C20) carboxylic acid or a metal salt thereof, perfluoroalkylcarboxylic acid(C7-C13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salt, a salt of perfluoroalkyl(C6-C10)-N-ethylsulfonylglycin and monoperfluoroalkyl(C6-C16) ethylphosphate. These may be used alone, or in combination.

As for the surfactant containing a fluoroalkyl group, a commercial product thereof can be used. Examples of the commercial product thereof include: SURFLON S-111, S-112, S-113 (all manufactured by Asahi Glass Co., Ltd.); FLUORAD FC-93, FC-95, FC-98, FC-129 (all manufactured by Sumitomo 3M Limited); UNIDYNE DS-101, DS-102 (all manufactured by DAIKIN INDUSTRIES, LTD.); MEGAFAC F-110, F-120, F-113, F-191, F-812, F-833 (all manufactured by DIC Corporation); EFTOP EF-102, 103, 104, 105, 112, 123A, 123B, 306A, 501, 201, 204 (all manufactured by Mitsubishi Materials Electronic Chemicals Co., Ltd.); and FUTARGENT F-100, F-150 (all manufactured by NEOS COMPANY LIMITED). These may be used alone, or in combination.

Examples of the cationic surfactant include an amine salt surfactant, a quaternary ammonium salt cationic surfactant, and a fluoroalkyl group-containing cationic surfactant. Examples of the amine salt surfactant include alkyl amine salts, amino alcohol fatty acid derivatives, polyamine fatty acid derivatives and imidazoline. Examples of the quaternary ammonium salt cationic surfactant include alkyltrimethylammonium salts, dialkyldimethylammonium salts, alkyl dimethyl benzyl ammonium salts, pyridinium salts, alkyl isoquinolinium salts and benzethonium chloride. Examples of the fluodoalkyl group-containing cationic surfactant include fluoroalkyl group-containing aliphatic primary or secondary amine acid, aliphatic quaternary ammonium salt such as a perfluoroalkyl(C6 to C10)sulfonic amide propyltrimethyl ammonium salts, benzalkonium salts, benzetonium chloride, pyridinium salts, and imidazolinium salts. These may be used alone, or in combination.

As for the cationic surfactant, a commercial product thereof can be used. Examples of the commercial product thereof include: SURFLON S-121 (manufactured by Asahi Glass Co., Ltd.); FLUORAD FC-135 (manufactured by Sumitomo 3M Limited); UNIDYNE DS-202 (manufactured by DAIKIN INDUSTRIES, LTD.); MEGAFAC F-150, F-824 (manufactured by DIC Corporation); EFTOP EF-132 (manufactured by Mitsubishi Materials Electronic Chemicals Co., Ltd.); and FUTARGENT F-300 (manufactured by NEOS COMPANY LIMITED). These may be used alone, or in combination.

Examples of the nonionic surfactant include a fatty acid amide derivative, and a polyhydric alcohol derivative.

Examples of the amphoteric surfactant include alanine, dodecyl di(aminoethyl)glycine, di(octylaminoethyl)glycine and N-alkyl-N,N-dimethylammonium betaine.

### —Removal of Organic Solvent—

A method for removing the organic solvent from the dispersion liquid, such as the emulsified slurry is appropriately selected depending on the intended purpose without any limitation. Examples of the method thereof include: a method where the entire reaction system is gradually heated to evaporate the organic solvent contained in oil droplets; and a method where a dispersion liquid is sprayed in a dry atmosphere to remove the organic solvent contained in oil droplets.

Once the organic solvent is removed, toner base particles are formed. The toner base particles can be subjected to washing, and drying, and may be further subjected to classification. As for the classification, a fine particle component may be removed by a cyclone in a liquid, a deconter, or centrifugal separation. The operation of the classification may be performed after the drying.

The obtained toner base particles may be mixed with particles, such as the external additives, and the charge controlling agent. In this process, particles, such as the external additives, are prevented from being detached from surfaces of toner base particles by applying a mechanical impact.

A method for applying the mechanical impact is appropriately selected depending on the intended purpose without any limitation, and examples thereof include; a method where an impact is applied to the mixture using a blade that rotates at high speed; and a method where the mixture is introduced into a high-speed air flow, and the speed is increased to crash the particles to each other, or to an appropriate impact board.

A device used for the aforementioned methods is appropriately selected depending on the intended purpose without any limitation, and examples thereof include an angmill (manufactured by Hosokawa Micron Corporation), a device the pulverization air pressure of which is reduced by modifying an I-type mill (manufactured by NIPPON PNEUMATIC MFG. CO., LTD.), a hybridization system (manufactured by NARA MACHINERY CO., LTD.), Cliptron System (manufactured by Kawasaki Heavy Industries, Ltd.), and an automatic mortar.

The glass transition temperature (Tg) of the toner is preferably 40° C. to 70° C., and more preferably 45° C. to 55° C. When the glass transition temperature thereof is 40° C. or higher, excellent heat resistance storage stability of the toner can be attained. When the glass transition temperature thereof is 70° C. or lower, sufficient low temperature fixability can be attained.

As for the storage elastic modulus of the toner, the temperature (TG′) at which the storage elastic modulus reaches 10,000 dyne/cm² with the measurement frequency of 20 Hz is preferably 100° C. or higher, more preferably 110° C. to 200° C. When the temperature (TG′) is lower than 100° C., the toner has poor hot offset resistance.

As for the viscosity of the toner, the temperature (Tη) at which the viscosity reaches 1,000 P with the measurement frequency of 20 Hz is preferably 180° C. or lower, more preferably 90° C. to 160° C. When the temperature (Tη) is 180° C. or lower, the toner has excellent low temperature fixability. Specifically, TG′ is preferably higher than Tη in view of achieving both low temperature fixability and hot offset resistance. In other words, the difference between TG′ and Tη(TG′−Tη) is preferably 0° C. or greater, more preferably 10° C. or greater, and even more preferably 20° C. or greater. Note that, the upper limit for the difference is not particularly limited.

Moreover, the difference between Tη and Tg is preferably 0° C. to 100° C., more preferably 10° C. to 90° C., and even more preferably 20° C. to 80° C., in view of both heat resistance storage stability and low temperature fixability.

### (Two-Component Developer)

The two-component developer of the present invention includes the toner of the present invention, and a magnetic carrier.

As the developer is a two-component developer, toner flowability is appropriately secured, and a developing step and a transferring step are appropriately performed. Moreover, a two-component developer having a high environment-resistant stability (reliability) can be provided.

### <Magnetic Carrier>

Examples of the magnetic carrier include iron powder, ferrite powder, magnetite powder, and resin-coated magnetic carrier, each having the average particle diameter of about 20 μm to about 200 μm. Among them, the resin-coated magnetic carrier is particularly preferable.

The coating resin is appropriately selected depending on the intended purpose without any limitation, and examples thereof include a urea-formaldehyde resin, a melamine resin, a benzoguanamine resin, a urea resin, a polyamide resin, an epoxy resin, a polyvinyl or polyvinylidene-based resin, an acrylic resin, a polymethyl methacrylate resin, polyacrylonitrile resin, a polyvinyl acetate resin, a polyvinyl alcohol resin, a polyvinyl butyral resin, a polystyrene resin, a styrene-acryl copolymer resin, a halogenated olefin resin (e.g., polyvinyl chloride), a polyester-based resin (e.g., polyethylene terephthalate resin, and polybutylene terephthalate), a polycarbonate-based resin, a polyethylene resin, a polyvinyl fluoride resin, a polyvinylidene fluoride resin, a polytrifluoroethylene resin, a polyhexafluoropropylene resin, a copolymer of vinylidene fluoride and an acryl monomer, a copolymer of vinylidene fluoride and vinyl fluoride, a fluoro terpolymer (e.g., a terpolymer of tetrafluoroethylene, vinylidene fluoride, and a non-fluoromonomer), and a silicone resin.

The coating resin may optionally contain a conductive powder. Examples of the conductive powder include a metal powder, carbon black, titanium oxide, tin oxide, and zinc oxide. The average particle diameter of the conductive powder is preferably 1 μm or smaller. When the average particle diameter thereof is 1 μm or smaller, electric resistance can be easily controlled.

A mass ratio of the magnetic carrier and toner in the two-component developer is appropriately selected depending on the intended purpose without any limitation, but the toner is preferably 1 part by mass to 10 parts by mass, relative to 100 parts by mass of the magnetic carrier.

### (Toner Accommodating Unit)

A toner accommodating unit of the present invention accommodates a toner in a unit having a function of accommodating the toner. Here, aspects of the toner accommodating unit are, for example, a toner accommodating container, a developing device, and a process cartridge.

The toner accommodating container is a container accommodating a toner.

The developing device includes a unit accommodating a toner, and configured to perform development.

The process cartridge integrally includes an image bearer and a developing unit, accommodates a toner, and is detachable to an image forming apparatus. The process cartridge may further include at least one selected from the group consisting of a charging unit, an exposing unit, and a cleaning unit.

When the toner accommodating unit of the present invention is mounted on the image forming apparatus to form an image, an image can be formed by using the toner that is excellent in high durability to folding and high heat resistant storage stability, and has excellent low temperature fixability.

### <Process Cartridge>

The process cartridge for use in the present invention includes at least a latent image bearer configured to bear an electrostatic latent image, and a developing unit containing a toner and configured to develop the electrostatic latent image born on the latent image bearer with the toner to form a visible image. The process cartridge may further contain appropriately selected other units, such as a charging unit, an exposing unit, a transferring unit, a cleaning unit, and a diselectrification unit, if necessary.

As for the toner, the toner of the present invention is used.

The developing unit contains at least a developer container configured to house the toner or the developer, and a developer bearing member configured to bear and transport the toner or developer housed in the developer container, and may further contain a layer thickness regulating member configured to regulate a toner layer thickness born on the developer bearing member. Specifically, either a one-component developing unit or a two-component developing unit explained in the image forming apparatus and image forming method described below can be suitably used.

Moreover, the charging unit, exposing unit, transferring unit, cleaning unit, and diselectrification unit are appropriately selected from those similar to units in the image forming apparatus described later.

The process cartridge can be detachably mounted in various electrophotographic image forming apparatuses, facsimiles, and printers. It is particularly preferred that the process cartridge be detachably mounted in the image forming apparatus of the present invention.

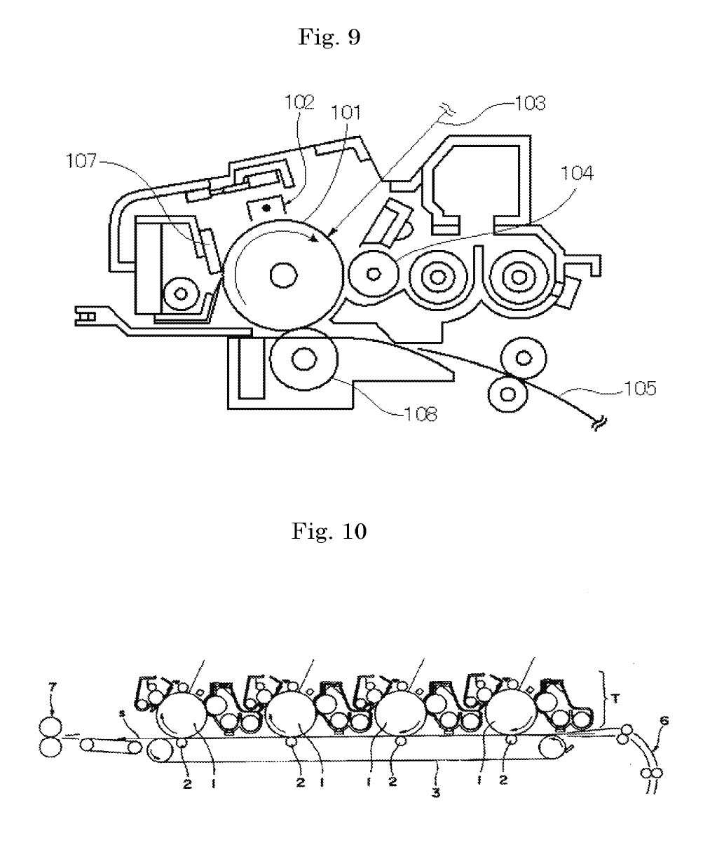

As illustrated in FIG. 9, for example, the process cartridge has a latent image bearer 101 built-in, and contains a charging unit 102, a developing unit 104, a transferring unit 108, and a cleaning unit 107, and may further contain other units, if necessary. In FIG. 9, 103 denotes exposure by an exposing unit, and 105 denotes a recording medium.

An image forming process performed by the process cartridge illustrated in FIG. 9 is explained next. An electrostatic latent image corresponding to an exposure image is formed on a surface of the latent image bearer 101 by charging by the charging unit 102, and exposure 103 by an exposing unit (not illustrated) with rotating the latent image bearer 101 in the direction depicted with the arrow. This electrostatic latent image is developed by the developing unit 104 to obtain a visible image, and the obtained visible image is transferred onto a recording medium 105 by the transferring unit 108, followed by printed out. Subsequently, the surface of the latent image bearer after the image transfer is cleaned by the cleaning unit 107, and the charge thereof is neutralized by a diselectrification unit (not illustrated). Then, the operation mentioned above is repeated.

### (Image Forming Apparatus and Image Forming Method)

The image forming apparatus of the present invention includes at least a latent image bearer, a charging unit, an exposing unit, a developing unit, a transferring unit, a fixing unit, and a cleaning unit, and may further include appropriately selected other units, if necessary. Note that, the charging unit and the exposing unit may be collectively referred to as an electrostatic latent image forming unit.

An image forming method for use in the present invention includes at least a charging step, an exposing step, a developing step, a transferring step, a fixing step, and a cleaning step, and may further include appropriately selected other steps, if necessary. Note that, the charging step and the exposing step may be collectively referred to as an electrostatic latent image forming step.

The image forming method for use in the present invention can be suitably carried out by the image forming apparatus of the present invention. The charging step can be carried out by the charging unit, the exposing step can be carried out by the exposing unit, the developing step can be carried out by the developing unit, the transferring step can be carried out by the transferring unit, the fixing step can be carried out by the fixing unit, the cleaning step can be carried out the cleaning unit, and the aforementioned other steps can be carried out by the aforementioned other units.

Since the image forming apparatus employs a tandem developing system where at least four developing units having different developing colors are aligned in series, the system speed thereof is 200 mm/sec to 3,000 mm/sec, a contact pressure by a fixing member is 10 N/cm² to 3,000 N/cm², and the fixing nip time is 30 msec to 400 msec, the image forming apparatus provides a color image forming apparatus, which can secure appropriate toner flowability in the high speed region of the system speed, can perform developing, transferring, and fixing, has fixing properties that deformation of a toner, or melt fixing of the toner on a recording medium, such as paper, under high pressure, can be appropriately controlled under the high pressure, as well as preventing hot offset, can appropriately control a heat quantity for fixing of the toner by appropriately setting the fixing nip time, and can secure appropriate image quality with less electricity consumption.

### <Latent Image Bearer>

A material, shape, structure, and size of the latent image bearer (may be referred to as an “electrostatic latent image bearer,” “electrophotographic photoconductor,” or “photoconductor” hereinafter) are appropriately selected from those known in the art without any limitation. Examples of the shape of the latent image bearer include a chum shape, and a belt shape. Examples of the material of the latent image bearer include an inorganic photoconductor (e.g., amorphous silicon, and selenium), and an organic photoconductor (OPC) (e.g., polysilane, and phthalopolymethine).

### <Charging Step and Charging Unit>

The charging step is a step including charging a surface of the latent image bearer, and is performed by the charging unit.

For example, the charging can be performed by applying a voltage to a surface of the latent image bearer using the charging unit.

The charging unit is appropriately selected depending on the intended purpose without any limitation, and examples thereof include a conventional contact charging device, equipped with an electroconductive or semiconductive roller, brush, film, or rubber blade, and a non-contact charging device utilizing corona discharge, such as corotron, and scorotron.

As for a shape of the charging unit, for example, any of a roller, a magnetic brush, or a fur brush can be used. The shape thereof can be selected depending on the specification and embodiment of the electrophotographic image forming apparatus. In the case where the magnetic brush is used, for example, the magnetic brush is composed of various ferrite particles (e.g., Zn—Cu ferrite) serving as a charging unit, a non-magnetic electroconductive sleeve configured to support the ferrite particles, and a magnet roll covered with the electroconductive sleeve. In the case where the brush is used, for example, a fur that is subjected to an electroconductive treatment with carbon, copper sulfide, metal, or metal oxide, is used as a material of the fur brush. A charger is formed by winding the aforementioned fur material around a core, which is a metal or another electroconductive-treated core, or bonding the fur material thereon.

The charger is not limited to the aforementioned contact-type charger, but use of the contact charger has an advantage that an image forming apparatus, in which an amount of ozone generated by the charger is reduced, can be attained.

It is preferred that the charger be provided in contact with the image bearer, or not in contact with the image bearer, and a surface of the latent image bearer be charged by applying superimposed AC voltage and DC voltage using the charger.

Moreover, another preferable embodiment is that a gap tape is provided to the latent image bearer, and the charger is a charging roller provided adjacent to the latent image bearer, in a non-contact manner, and configured to charge a surface of the latent image bearer by applying superimposed AC voltage and DC voltage to the charging roller.

### <Exposing Step and Exposing Unit>

The exposing step is a step containing exposing the surface charged of the latent image bearer to light, and is performed by the exposing unit.

The exposure can be performed by exposing the surface of the latent image bearer to light imagewise using the exposing unit.

An optical system used in the exposure is roughly classified into an analog optical system, and a digital optical system. The analog optical system is an optical system, which directly projects a document on the latent image bearer, and the digital optical system is an optical system, which receives image information as electric signals, and turns the electric signals into optical signals to expose the electrophotographic photoconductor to light to form an image.

The exposing unit is appropriately selected depending on the intended purpose without any limitation, provided that it is capable of exposing the surface of the latent image bearer, which has been charged by the charging unit, to light imagewise to be formed. Examples thereof include various exposure devices, such as a copy optical system, a rod lens array system, a laser optical system, a crystal shutter optical system, and a LED optical system.

Note that, in the present invention, employed for the exposing may be a back-light system where imagewise exposure is performed from the back side of the latent image bearer.

### <Developing Step and Developing Unit>

The developing step is a step containing developing the electrostatic latent image with the toner to form a visible image.

For example, the formation of the visible image can be performed by developing the electrostatic latent image using the toner, and can be performed by the developing unit.

The developing unit is appropriately selected from those known in the art without any limitation, provided that it can perform developing using the toner. Preferable examples of the developing unit include a unit containing at least a developing device capable of applying the toner to the electrostatic latent image in a contact or non-contact manner.

The developing device may employ a dry developing system, or a wet developing system, and may be a single-color developing device, or a multi-color developing device. Preferable examples thereof include a device containing a stirrer configured to friction stir the toner to charge the toner, and a rotatable magnet roller.

For example, the toner, and optionally a carrier are mixed and stirred inside the developing device. The toner is charged by the friction caused by the stirring, and is held on a surface of the rotating magnet roller in a state of a brush, to thereby form a magnetic brush. The magnetic roller is provided adjacent to the electrostatic latent image bearing member. Therefore, part of the toner constituting the magnetic brush formed on the surface of the magnetic roller is transferred onto a surface of the latent image bearing member by electric suction force. As a result, the electrostatic latent image is developed with the toner, to form a toner image formed of the toner on the latent image bearing member.

The toner to be housed in the developing device may be a developer containing the toner. The developer may be a one-component developer, or a two-component developer.

### <Transferring Step and Transferring Unit>

The transferring step is a step containing transferring the visible image onto a recording medium. As for the transferring step, a preferred embodiment is an embodiment where an intermediate transfer member is used, and the visible image is secondary transferred onto the recording medium, after primary transferring the visible image onto the intermediate transfer member. The more preferred embodiment is an embodiment using two colors or more, preferably a full-color toner as the toner, and containing a primary transferring step and a secondary transferring step, where the primary transferring step contains transferring visible images onto the intermediate transfer member to form a composite transfer image, and the secondary transferring step contains transferring the composite transfer image onto a recording medium.

For example, the transferring can be performed by charging the latent image bearer using the transferring unit to transfer the visible image, and can be performed by the transferring unit. The preferred embodiment of the transferring unit is that the transferring unit contains a primary transferring unit configured to transfer visible images onto an intermediate transfer member to form a composite transfer image, and a secondary transferring unit configured to transfer the composite transfer image onto a recording medium.

Note that, the intermediate transfer member is appropriately selected from conventional transfer members depending on the intended purpose without any limitation, and examples thereof include a transfer belt.

The transferring unit (the primary transferring unit, the secondary transferring unit) preferably contains at least a transferring element configured to charge the visible image formed on the latent image bearer and release the visible image to the side of the recording medium. The number of the transferring units may be one or two or more. Examples of the transferring element include a corona transfer charger using corona discharge, a transfer belt, a transfer roller, a pressure transfer roller, and an adhesion transferring element.

Note that, the recording medium is typically plain paper, but the recording medium is appropriately selected depending on the intended purpose without any limitation, provided that it can receive a non-fixed image after developing. A PET base for OHP can be also used as the recording medium.

### <Fixing Step and Fixing Unit>

The fixing step is a step including fixing the transferred toner image onto a recording medium, and the fixing can be performed by the fixing unit. In the case where two or more color toners are used, fixing may be performed every time when a toner of each color is transferred to a recording medium, or fixing is performed in a state where toners of all colors are transferred and laminated on a recording medium. The fixing unit is not particularly limited, and can employ a heat fixing system using a conventional heat pressure member. Examples of the heat pressure member include a combination of a heating roller and a pressure roller, and a combination of a heating roller, a pressure roller, and an endless belt. During fixing, the heating temperature is appropriately selected depending on the intended purpose without any limitation, but the temperature is preferably 80° C. to 200° C. Optionally, for example, a conventional light fixing device may be used in combination with the fixing unit.

### <Cleaning Step and Cleaning Unit>

The cleaning step is a step containing removing the toner remained on the latent image bearer, and can be suitably performed by the cleaning unit.

The cleaning unit is appropriately selected from conventional cleaners without any limitation, provided that it can remove the toner remained on the latent image bearer. Examples thereof include a magnetic brush cleaner, a static brush cleaner, a magnetic roller cleaner, a cleaning blade, a brush cleaner, and a web cleaner. Among them, a cleaning blade is particularly preferable, as the cleaning blade has a high performance for removing the toner, and is small in the size and inexpensive.

Examples of a material of a rubber blade used for the cleaning blade include urethane rubber, silicone rubber, a fluorine rubber, chloroprene rubber, and butadiene rubber. Among them, urethane rubber is particularly preferable.

### <Other Steps and Other Units>

Examples of the aforementioned other units include a diselectrification unit, a recycle unit, and a controlling unit.

Examples of the aforementioned other steps include a diselectrification step, a recycle step, and a controlling step.

### —Diselectrification Step and Diselectrification Unit—

The diselectrification step is a step containing applying diselectrification bias to the latent image bearer to discharge the latent image bearer, and can be suitably performed by the diselectrification unit.

The diselectrification unit is appropriately selected from conventional dischargers without any limitation, provided that it can apply diselectrification bias to the image bearer. Examples thereof include a diselectrification lamp.

### —Recycle Step and Recycle Unit—

The recycle step is a step including recycling the toner removed by the cleaning step to the developing unit. The recycle step is suitably performed by the recycle unit.

The recycle unit is not particularly limited, and examples thereof include conventional conveyance units.

### —Controlling Step and Controlling Unit—

The controlling step is a step containing controlling each of the aforementioned step, and can be suitably performed by the controlling unit.

The controlling unit is appropriately selected depending on the intended purpose without any limitation, provided that it can control the operations of each of the aforementioned units. Examples thereof include devices, such as a sequencer, and a computer.

One example of the image forming apparatus is explained with reference to drawings.

The tandem image forming apparatus is composed by aligning pluralities of image forming elements, each including at least a latent image bearer, a charging unit, a developing unit, and a transferring unit, in series. This tandem image forming apparatus is equipped with four image forming elements, respectively for yellow, magenta, cyan, and black. Visible images are formed in the four image forming elements in parallel, and the formed visible images are superimposed on a recording medium or an intermediate transfer member. Therefore, a full-color image can be formed at high speed.

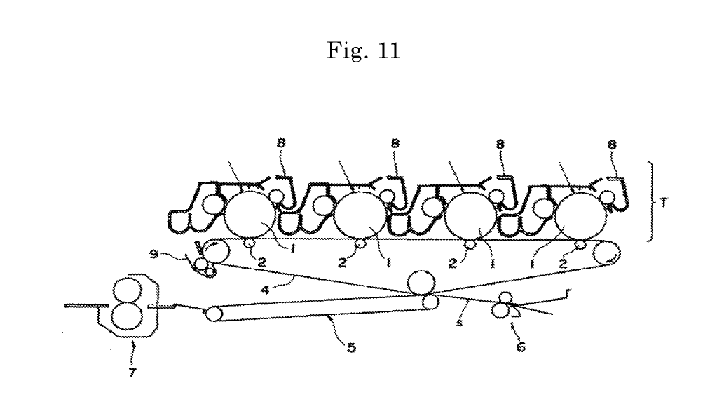

As for the tandem image forming apparatus, there are (1) a direct transfer system where, as illustrated in FIG. 10, visible images formed on the respective latent image bearers 1 are sequentially transferred, by a transferring unit 2, onto a recording medium S, a surface of which travels in a manner that it passes through a transfer position that in the counter region to the latent image bearers 1 of the image forming units, and (2) an indirect transfer system where, as illustrated in FIG. 11, after sequentially transferring visible images on the latent image bearers 1 of the image forming elements temporarily onto an intermediate transfer member 4 by a transferring unit (primary transferring unit) 2, the images on the intermediate transfer member 4 are collectively transferred onto a recording medium S by a secondary transferring unit 5. Note that, a transfer conveyance belt is used as the secondary transferring unit in FIG. 11, the secondary transferring unit may be in a shape of a roller.

Comparing the (1) direct transfer system and the (2) indirect transfer system, an installation size of the (1) direct transfer system becomes large in the recording medium transporting direction, because a paper feeding device 6 needs to be provided at the upstream side of the tandem image forming unit T, in which latent image bearers 1 are aligned, and a fixing device 7 serving as the fixing unit needs to be provided at the downstream side of the tandem image forming unit T. On the other hand, a secondary transfer position can be relatively freely designed in the (2) indirect transfer system, the paper feeding device 6 and the fixing device 7 can be arranged to vertically overlapped with the tandem image forming unit T, so that a size of the system can be reduced.

In the (1) direct transfer system, moreover, the fixing device 7 is provided close to the tandem image forming unit T in order to prevent the size thereof large along the recording medium transporting direction. Therefore, the fixing device 7 cannot be provided with a sufficient space so that the recording medium S can be bent, and hence the fixing device 7 tends to affect the image formation of the upstream side by the impact caused when the edge of the recording medium S enters into the fixing device 7 (which becomes significant specially with a thick recording medium), or a difference in the speed between the conveying speed of the recording medium passing through the fixing device 7, and the transporting speed of the recording medium by the transfer conveyance belt. On the other hand, the fixing device 7 hardly affects image formation in the (2) indirect transfer system, as the fixing device 7 can be provided with a sufficient space so that the recording medium S can be bent.

From the reasons as mentioned above, an intermediate transfer system has been currently particularly noted. As illustrated in FIG. 11, in such the color image forming apparatus, the toner residues remained on the latent image bearer 1 after the transferring is removed by the cleaning device 8 serving as the cleaning unit after the primary transferring to clean the surface of the latent image bearer 1, so that the latent image bearer 1 is ready for the next image formation process. Moreover, the toner residues remained on the intermediate transfer member 4 after the transferring is removed by the intermediate transfer member cleaning device 9 after the secondary transferring to clean the surface of the intermediate transfer member 4, to thereby make the intermediate transfer member 4 ready for the next image formation process.

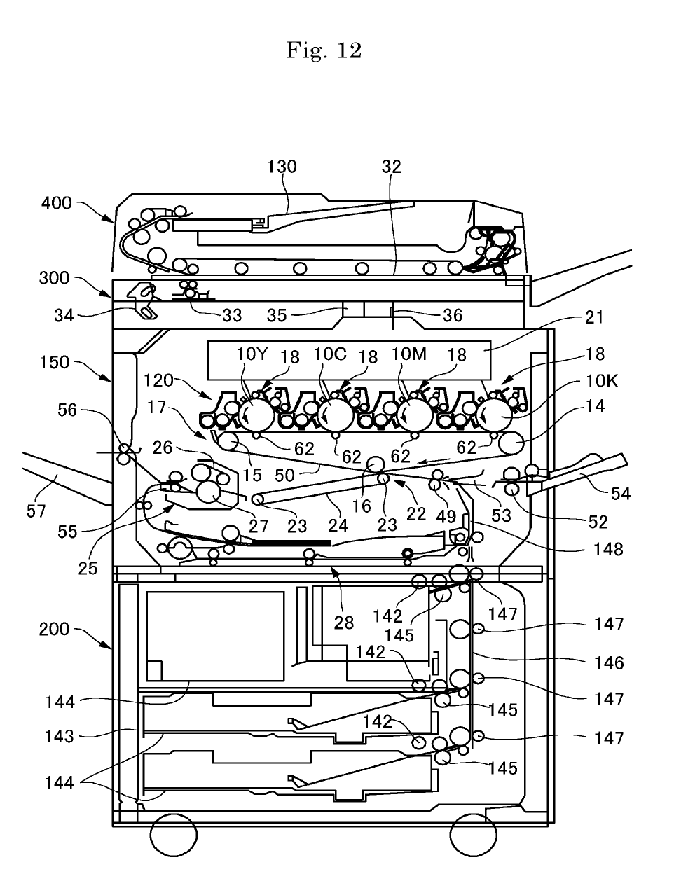

The tandem image forming apparatus illustrated in FIG. 12 is a tandem color image forming apparatus. This tandem color image forming apparatus contains a copier main body 150, a paper feeding table 200, a scanner 300, and an automatic document feeder (ADF) 400.

In the central part of the copier main body 150, an intermediate transfer member 50 in the form of an endless belt is provided. The intermediate transfer member 50 is rotatably supported by support rollers 14, 15, and 16 in the clockwise direction in FIG. 12. In the surrounding area of the support roller 15, an intermediate transfer member cleaning unit 17 configured to remove the residual toner on the intermediate transfer member 50 is provided. To face the intermediate transfer member 50 supported by the support roller 14 and the support roller 15, a tandem developing unit 120, in which four image forming units 18, i.e. yellow, cyan, magenta, and black image forming units, are aligned along the traveling direction of the intermediate transfer member 50, is provided. In the surrounding area of the tandem developing unit 120, the exposing device 21 is provided. A secondary transferring unit 22 is provided at the opposite side of the intermediate transfer member 50 to the side where the tandem developing unit 120 is provided. In the secondary transferring unit 22, a secondary transfer belt 24, which is an endless belt, is supported by a pair of rollers 23, and is designed so that a recording medium transported on the secondary transfer belt 24 and the intermediate transfer member 50 can be in contact with each other. In the surrounding area of the secondary transferring unit 22, a fixing device 25 is provided.

Note that, a sheet reverser 28 configured to reverse the recording medium to perform image formation on both sides thereof is provided in the surrounding area of the secondary transferring unit 22 and the fixing device 25.

Next, formation of a full-color image (color copy) using the tandem developing unit 120 is explained. Specifically, first, a document is set on a document table 130 of the automatic document feeder (ADF) 400. Alternatively, the automatic document feeder (ADF) 400 is opened, a document is set on a contact glass 32 of the scanner 300, and then the ADF 400 is closed.

In the case where the document is set on the ADF 400, once a start switch (not illustrated) is pressed, the document is transported onto the contact glass 32, and then the scanner 300 is driven to scan the document with a first carriage 33 and a second carriage 34. In the case where the document is set on the contact glass 32, the scanner 300 is immediately driven to scan the document with the first carriage 33 and the second carriage 34. During this scanning operation, light applied from a light source of the first carriage 33 is reflected on the surface of the document, the reflected light from the document is further reflected by a mirror of the second carriage 34, and passed through an image formation lens 35, which is then received by a read sensor 36. In this manner, the color document (color image) is read, and image information of black, yellow, magenta, and cyan is obtained.

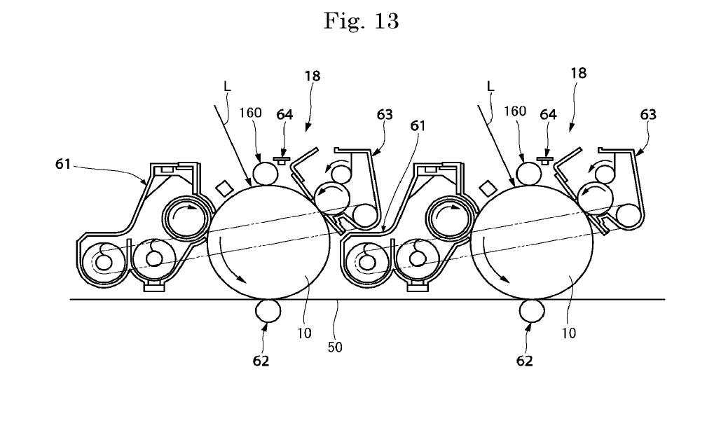

The image information of each color, black, yellow, magenta or cyan, is transmitted to the respective image forming unit 18 (a black image forming unit, a yellow image forming unit, a magenta image forming unit, and a cyan image forming unit) of the tandem developing unit 120, and by each image forming unit, a respective toner image, i.e. of black, yellow, magenta, or cyan, is formed. Specifically, each image forming unit 18 (the black image forming unit, the yellow image forming unit, the magenta image forming unit, or the cyan image forming unit) of the tandem developing unit 120 is, as illustrated in FIG. 12, equipped with a latent image bearer 10 (a latent image bearer for black 10K, a latent image bearer for yellow 10Y, a latent image bearer for magenta 10M, and a latent image bearer for cyan 10C), a charging device 160 configured to uniformly charge the latent image bearer 10, an exposing device configured to expose the latent image bearer to imagewise light (L in FIG. 13) corresponding to each color based on the respective color image information to form an electrostatic latent image corresponding to each color image on the latent image bearer, a developing device 61 configured to develop each electrostatic latent image with each color toner (a black toner, yellow toner, magenta toner, or cyan toner) to form a toner image of each of the color toners, a transfer charger 62 configured to transfer the toner images onto an intermediate transfer member 50, a cleaning device 63, and a diselectrification charger 64. The image forming units can form single color images of respective color (a black image, a yellow image, a magenta image, and a cyan image) corresponding to the respective image information of respective color. The black image, yellow image, magenta image, and cyan image formed in this manner are transferred to the intermediate transfer member 50 rotatably supported by the support rollers 14, 15, and 16 in the following manner. Specifically, the black image formed on the latent image bearer for black 10K, the yellow image formed on the latent image bearer for yellow 10Y, the magenta image formed on the latent image bearer for magenta 10M, and the cyan image formed on the latent image bearer for cyan 10C are successively transferred (primary transferred) onto the intermediate transfer member 50. Then, the black image, the yellow image, the magenta image, and the cyan image are superimposed on the intermediate transfer member 50 to form a composite color image (a color transfer image).

In the paper feeding table 200, meanwhile, one of the paper feeding rollers 142 is selectively rotated to eject recording mediums from one of multiple paper feeding cassettes 144 of the paper bank 143, the ejected recording mediums are separated one by one by a separation roller 145 to send each recording medium to a paper feeding path 146, and then transported by a transport roller 147 into a paper feeding path 148 within the copier main body 150. The recording medium transported in the paper feeding path 148 is then bumped against a registration roller 142 to stop. Alternatively, the recording mediums on a manual-feeding tray 54 are ejected by rotating a paper feeding roller 142, separated one by one by a separation roller 145 to guide into a manual paper feeding path 53, and then bumped against the registration roller 49 to stop. Note that, the registration roller 49 is generally earthed at the time of the use, but it may be biased for removing paper dusts of the recording mediums. Next, the registration roller 49 is rotated synchronously with the movement of the composite color image (color transfer image) on the intermediate transfer member 50, to thereby send the recording medium between the intermediate transfer member 50 and the secondary transferring unit 22. The composite color image (color transfer image) is then transferred (secondary transferred) to the recording medium by the secondary transferring unit 22, to thereby form the color image on the recording medium. Note that, after transferring the image, the residual toner on the intermediate transfer member 50 is cleaned by the intermediate transfer member cleaning device 17.

The recording medium, on which the color image has been transferred, is transported by the secondary transferring unit 22 to the fixing device 25. In the fixing device 25, the composite color image (the color transfer image) is fixed on the recording medium with heat and pressure applied. Thereafter, the recording medium is changed its traveling direction by a switch craw 55, ejected by an ejecting roller 56, and then stacked on an output tray 57. Alternatively, the recording medium is changed its traveling direction by the switch craw 55, reversed by the sheet reverser 28 to again send to a transfer position, to thereby record an image on the back side thereof. Then, the recording medium is ejected by the ejecting roller 56, and stacked on the output tray 57.

### EXAMPLES

Examples of the present invention are explained hereinafter, but these examples shall not be construed as to limit the scope of the present invention in any way. Note that, in the descriptions below, “part(s)” denotes “part(s) by mass.”

### Example 1

### Preparation of Particle Dispersion Liquid

A reaction vessel equipped with a stirring bar and a thermometer was charged with 683 parts of water, 11 parts of sodium salt of sulfuric acid ester of methacrylic acid-ethylene oxide adduct (ELEMINOL RS-30, manufactured by Sanyo Chemical Industries, Ltd.), 10 parts of polylactic acid, 60 parts of styrene, 100 parts of methacrylic acid, 70 parts of butyl acrylate, and 1 part of ammonium persulfate, and the resulting mixture was stirred for 30 minutes at 3,800 rpm, to thereby obtain a white emulsion. The obtained emulsion was heated until the internal system temperature reached 75° C., and was allowed to react for 4 hours. Subsequently, a 1% by mass aqueous ammonium persulfate solution (30 parts) was added to the reaction mixture, followed by aging for 6 hours at 75° C., to thereby prepare an aqueous dispersion liquid of a vinyl-based resin (a copolymer of styrene/methacrylic acid/butyl acrylate/sodium salt of sulfuric acid ester of methacrylic acid ethylene oxide adduct) [Particle Dispersion Liquid 1].

### <Preparation of Aqueous Phase>

Water (990 parts by mass), 83 parts of [Particle Dispersion Liquid 1], 37 parts of a 60.4% sodium dodecyldiphenyl ether disulfonate aqueous solution (ELEMINOL MON-7, manufactured by Sanyo Chemical Industries, Ltd.), and 90 parts of ethyl acetate were mixed together and stirred, to thereby obtain a milky white fluid, which was used as [Aqueous Phase 1].

### <Synthesis of Prepolymer>

A reaction vessel equipped with a cooling tube, a stirrer, and a nitrogen-inlet tube was charged with 1,176 parts of bisphenol A ethylene oxide (2 mol) adduct, 140 parts of bisphenol A propylene oxide (2 mol) adduct, 488 parts of terephthalic acid, 38 parts of trimellitic anhydride, and 4 parts of dibutyl tin oxide. The resulting mixture was allowed to react for 7 hours at 230° C. under normal pressure, followed by reacting for 5 hours under the reduced pressure of 10 mmHg to 15 mmHg, to thereby obtain [Intermediate Polyester 1].

Subsequently, a reaction vessel equipped with a cooling tube, a stirrer, and a nitrogen-inlet tube was charged with 1,845 parts of [Intermediate Polyester 1], 405 parts of isophorone diisocyanate, and 2,000 parts of ethyl acetate, and the resulting mixture was allowed to react for 5 hours at 100° C., to thereby obtain [Prepolymer 1].

### <Synthesis of Ketimine>

A reaction vessel equipped with a stirring bar and a thermometer was charged with 57 parts of isophorone diamine, and 25 parts of methyl ethyl ketone, and the resulting mixture was allowed to react for 4 hours and a half at 50° C., to thereby obtain [Ketimine Compound 1].

### <Synthesis of Non-Crystalline Polyester Resin 1>

A vessel equipped with a stirrer and a thermoset was charged with 2,250 parts of [Prepolymer 1], 70 parts of [Ketimine Compound 1], and 2,500 parts of ethyl acetate, and the resulting mixture was stirred for 4 hours at 80° C., followed by removing the solvent for 8 hours at 30° C., to thereby obtain [Non-Crystalline Polyester Resin 1].

### <Synthesis of Crystalline Polyester Resin 1>

A reaction vessel equipped with a cooling tube, a stirrer, and a nitrogen-inlet tube was charged with 1,200 parts of 1,6-hexanediol, 1,200 parts of decanedioic acid, 0.4 parts of dibutyl tin oxide serving as a catalyst. Thereafter, the air inside the vessel was turned into an inert atmosphere with nitrogen gas by decompression, and the mixture in the vessel was mechanically stirred for 4 hours at 180 rpm. Thereafter, the resultant was gradually heated to 210° C. under the reduced pressure, followed by stirring for 1.5 hours. Once the mixture became viscous, the mixture was air-cooled to stop the reaction, to thereby obtain [Crystalline Polyester Resin 1].

### <Preparation of Polyester Resin 1 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. The filtration cake was dried with the filter paper, and 50% of the dried filtration cake was added to the recovery flask containing the filtrate therein. The solvent was removed from the resulting mixture for 8 hours at 30° C., to thereby obtain [Polyester Resin 1 Containing Amorphous Segment and Crystalline Segment (Copolymer 1)].

### <Synthesis of Master Batch 1 (MB 1)>

Water (500 parts), 50 parts of carbon black (Printex35 JY-C32, particle size: 24 nm, manufactured by Evonik Degussa Japan Co., Ltd.), and 450 parts of [Polyester Resin 1 Containing Amorphous Segment and Crystalline Segment (Copolymer 1)] were added together, followed by mixing with HENSCHEL MIXER (manufactured by Nippon Cole & Engineering Co., Ltd.). The resulting mixture was kneaded for 1 hour at 110° C. by means of twin-roller kneader, then rolled out and cooled, followed by ground by a pulverizer, to thereby obtain [Master Batch 1 (MB 1)].

### <Preparation of Oil Phase (Pigment/Wax Dispersion Liquid)>

A vessel equipped with a stirring bar and a thermometer was charged with 1,900 parts of [Polyester Resin 1 Containing Amorphous Segment and Crystalline Segment (Copolymer 1)], 120 parts of paraffin wax (HNP-11, manufactured by Nippon Seiro Co., Ltd.), and 947 parts of ethyl acetate, and the resulting mixture was heated to 80° C. with stirring. After maintaining the temperature at 80° C. for 5 hours, the mixture was cooled to 30° C. over 1 hour. Subsequently, 500 parts of [Master Batch 1 (MB 1)], and 500 parts of ethyl acetate were added to the vessel, and the resulting mixture was mixed for 1 hour to thereby obtain [Raw Material Solution 1].

[Raw Material Solution 1] (1,324 parts) was transferred to another vessel, and the carbon black and wax therein were dispersed by means of a bead mill (ULTRA VISCOMILL, manufactured by AIMEX CO., Ltd.) under the conditions: a liquid feed rate of 1.5 kg/hr, disk circumferential velocity of 3 m/sec, 0.5 mm-zirconia beads packed to 80% by volume, and 2 passes, to thereby obtain [Pigment/Wax Dispersion Liquid (1)], namely [Oil Phase (1)].

### <Emulsification and Removal of Solvent>

A vessel was charged with 749 parts of [Oil Phase (1)], followed by mixing [Oil Phase (1)] by means of TK Homomixer (manufactured by PRIMIX Corporation) at 5,000 rpm for 5 minutes. Then, 1,200 parts of [Aqueous Phase 1] was added to the vessel, and the resulting mixture was mixed for 1.5 hours by means of TK Homomixer at the rotational speed of 10,000 rpm, to thereby obtain [Emulsified Slurry 1].

A vessel equipped with a stirrer and a thermometer was charged with [Emulsified Slurry 1], and the solvent therein was removed for 8 hours at 30° C., followed by maturing for 72 hours at 50° C., to thereby obtain [Dispersion Slurry 1].

### <Washing and Drying>

After filtering 100 parts of [Dispersion Slurry 1] under the reduced pressure, washing and drying was performed in the following manner.

(1): To the filtration cake, 100 parts of ion-exchanged water was added, and the mixture was mixed (for 10 minutes at the rotational speed of 12,000 rpm) by TK Homomixer, followed by filtering the mixture.
(2): To the filtration cake obtained in (1), 100 parts of a 10% by mass sodium hydroxide aqueous solution was added, and the mixture was mixed (for 30 minutes at the rotational speed of 12,000 rpm) by TK Homomixer, followed by filtering the mixture under the reduced pressure.
(3): To the filtration cake obtained in (2), 100 parts of 10% by mass hydrochloric acid was added, and the mixture was mixed (for 10 minutes at the rotational speed of 12,000 rpm) by TK Homomixer, followed by filtering the mixture.
(4): To the filtration cake obtained in (3), 300 parts of ion-exchanged water was added, and the mixture was mixed (for 10 minutes at the rotational speed of 12,000 rpm) by the TK Homomixer, followed by filtering the mixture.

The series of the aforementioned operations was performed twice, to thereby obtain [Filtration Cake 1].

[Filtration Cake 1] was dried with an air-circulating drier for 48 hours at 45° C., and was then passed through a sieve with a mesh size of 75 μm, to thereby obtain [Toner Base Particles 1].

Thereafter, 100 parts of [Toner Base Particles 1], and 1 part of hydrophobic silica having the average particle diameter of 13 nm were mixed by means of HENSCHEL MIXER, to thereby obtain [Toner 1].

Various physical properties of [Toner 1] were measured by the following methods. The results are presented in Table 1.

### <Method for Measuring Molecular Weight Distribution by GPC Using THF as Solvent, and for Determining M_{THF}>

A molecular weight (M_{THF}) of a peak-top of a peak whose differential molecular distribution value was maximum in a differential molecular weight distribution curve derived from the resin obtained by GPC of the toner using tetrahydrofuran (THF) as a solvent was evaluated in the following manner.

The evaluation was performed using HLC-8220GPC (column: TSKgel) manufactured by Tosoh Corporation. The toner (6.0 mg) was weighted and collected in a sample tube, followed by adding THF until a total amount thereof became 4 g. The resulting mixture was then stirred. When any remaining without being dissolved could be visually observed, the sample tube was placed in an ultrasonic cleaning device for 30 seconds. The sample was left to stand for 24 hours. Then, the supernatant liquid of the sample was suctioned by a syringe by 2 cm³, followed by transferring into a sample cup for a measurement via a chromatodisc (0.45 μm, 25 N, manufactured by KURABO INDUSTRIES LTD.), which was then provided for the measurement.

The measuring conditions were as follows:

Mobile phase: THF

Flow rate: 0.35 mL/min

Temperature: 40° C.

Detector: RI

Sample amount: 10 μL

The data analysis was performed using a calibration curve prepared using standard samples (Shodex STANDARD SM-105, manufactured by SHOWA DENKO K.K.). A molecular weight (M_{THF}) of a peak-top of a peak whose differential molecular distribution value derived from the resin was maximum was calculated from the obtained differential molecular weight distribution curve.

Note that, when the pigment contained in the toner is included in the measuring sample, the pigment may be detected as a peak. However, this peak needs to be disregarded, as it is not peak derived from the resin. As for a method for judging the obtained peak is derived from a resin or pigment, there is a method, in which a pigment per se is measured under the same conditions, and a position of a peak of the pigment is determined. Since the pigment is present in a sample as a large solid insoluble to HFIP, the pigment is eluted at the first stage, without being adsorbed by the column, and often appears as a peak of the largest molecule. Therefore, it is necessary to carefully judge especially when the solution passed through the cromatodisc (0.45 μm, 25 N, manufactured by KURABO INDUSTRIES LTD.) is tinted during the sampling. In the present specification, a peak denotes a part corresponding to a convex portion in the obtained molecular weight distribution.

In FIG. 1A, A is regarded as a peak because an increase the differential molecular distribution value is observed again at the higher molecular weight side from the main peak. In FIG. 1A, B is not regarded as a peak because no increase in the differential molecular distribution value is observed at the higher molecular weight side after the main peak, and the differential molecular distribution value is merely gradually decreased. The definition of the peak is the same in the analysis of the molecular weight distribution obtained by GPC using HFIP as a solvent.

### <Measurement of Molecular Weight Distribution by GPC Using HFIP as Solvent>

A differential molecular weight distribution curve derived from the resin obtained by GPC of the toner using HFIP as a solvent was evaluated in the following manner.

The evaluation was performed using HLC-8220GPC (column: TSKgel) manufactured by Tosoh Corporation. The toner (6.0 mg) was weighted and collected in a sample tube, followed by adding HFIP until a total amount thereof became 4 g. The resulting mixture was then stirred. When any remaining without being dissolved could be visually observed, the sample tube was placed in an ultrasonic cleaning device for 30 seconds. The sample was left to stand for 24 hours. Then, the supernatant liquid of the sample was suctioned by a syringe by 2 cm³, followed by transferring into a sample cup for a measurement via a chromatodisc (0.45 μm, 25 N, manufactured by KURABO INDUSTRIES

LTD.), which was then provided for the measurement.

The measuring conditions were as follows.

Mobile phase: HFIP

Flow rate: 0.20 mL/min

Temperature: 40° C.

Detector: RI

Sample amount: 10 μL

The data analysis was performed using a calibration curve prepared using standard samples (EasiCal PM-1 Polymethylmethacrylate Standards, manufactured by Polymer Laboratories).

Note that, when the pigment contained in the toner is included in the measuring sample, the pigment may be detected as a peak. However, this peak needs to be disregarded, as it is not peak derived from the resin. As for a method for judging the obtained peak is derived from a resin or pigment, there is a method, in which a pigment per se is measured under the same conditions, and a position of a peak of the pigment is determined. Since the pigment is present in a sample as a large solid insoluble to HFIP, the pigment is eluted at the first stage, without being adsorbed by the column, and often appears as a peak of the largest molecule. Therefore, it is necessary to carefully judge especially when the solution passed through the cromatodisc (0.45 μm, 25 N, manufactured by KURABO INDUSTRIES LTD.) is tinted during the sampling.

### <Method for Determining Pmax and M_{Pmax}>

The maximum peak (Pmax) present at the molecular weight of 5×10⁴ or less in the present invention was evaluated in the following method. In the manner as described above, GPC was performed using

HFIP as a solvent, and the obtained differential molecular weight distribution curve was analyzed. Among peaks present at the molecular weight of 5×10⁴ or less, the peak whose differential molecular distribution value was the largest was determined as Pmax. Moreover, a molecular weight of a peak-top of the Pmax was determined as M_{Pmax}.

### <Method for Counting Peaks>

In the manner as described above, GPC was performed using HFIP as a solvent, and the obtained differential molecular weight distribution curve was analyzed. At first, a position of Pmax was determined by the aforementioned method. The peaks present at the higher molecular weight side of the Pmax were determined as Pmax+1, Pmax+2 . . . Pmax+n from the closest to the furthest to the Pmax (see FIG. 3). A state where there is no peak at the higher molecular weight side of the Pmax denotes a state where n=0 (see FIG. 4). A state where there is only one peak at the higher molecular weight side of the Pmax denotes a state where n=1. A state where there is more than two peaks at the higher molecular weight side of the Pmax denotes a state where n≧2. When the peaks were counted, peaks at the lower molecular weight side of the Pmax were not included.

### <Method for Determining Molecular Weight Difference of Peak-Topes>

A difference in the molecular weight between the peak-tops in the present invention was measured in the following manner. In the manner as described above, GPC was performed using HFIP as a solvent, and the obtained differential molecular weight distribution curve was analyzed. In the case where there was only one peak at the higher molecular weight side of the Pmax (this peak was determined as Pmax+1), a difference between a molecular weight of the peak-top of the Pmax+1 (determined as M_{Pmax+1}) and M_{Pmax} was determined as the molecular weight difference between the peak-tops (see FIG. 5, and Formula (3)).

Molecular weight difference=M_{Pmax+1}−M_{Pmax} Formula (3)

### <Method for Determining Peak Area>

The peak area in the present invention was determined in the following manner. In the manner as described above, GPC was performed using HFIP as a solvent, and the obtained differential molecular weight distribution curve was analyzed. A vertical line was drawn from each convex present between the peaks (a point at which the differential molecular distribution value became the minimum between the peaks) to divide into each peak, and a ratio of the peak area of each peak was calculated. In this process, a base line was drawn horizontally from the elution onset point of the sample.

The peak area of the Pmax was determined as a, the peak area of the Pmax+1 was determined as b, the peak area of the Pmax+2 was determined as c, and the peak area of the Pmax+3 was determined as d, and then calculations were carried out (see FIG. 6).

The phrase “In the case where peaks are present at the higher molecular weight side of the Pmax, a total area of the peaks is 35% or less of the area of the Pmax” denotes a state where Formula (1) below is satisfied.

(b+c+d)/a×100≦35 Formula (1)

The phrase “In the case where there are two or more peaks at the higher molecular weight side of the Pmax, a total area of the peaks is a total peak area of the peaks that are second and subsequent peaks counted from the peak closest to the Pmax is 15% or less of the area of the Pmax” denotes a state where Formula (2) below is satisfied.

(c+d)/a×100≦15 Formula (2)

### <Method for Determining Half Value Width of Pmax>

The half value width of the Pmax was evaluated in the following manner. In the manner as described above, GPC was performed using HFIP as a solvent, Pmax was determined from the obtained differential molecular weight distribution curve. The width of the chart (full width at half maximum) at the position where the differential molecular distribution value of the peak-top of the Pmax became a half value was determined as a half value width in the present invention (see FIG. 7). In the case where peaks were superimposed and a full width at half maximum could not be determined, a value obtained by determining a half width at half maximum, and multiplying the half width at half maximum with 2 was determined as a half value width (see FIG. 8). In the case where peaks were superimposed in the more complex manner, a half value width was determined by performing peak separation through fitting using a least-squares method, followed by determining a width of the chart (full width at half maximum).

Subsequently, a two-component developer was produced using the above-produced toner in the following manner.

### <Production of Carrier>

### —Core Material—

Mn ferrite particles (mass average particle diameter: 35 μm): 5,000 parts

### —Coating Materials—

Toluene: 450 parts

Silicone resin (SR2400, manufactured by Dow Corning Toray Co., Ltd., nonvolatile component: 50% by mass): 450 parts

Aminosilane (SH6020, manufactured by Dow Corning Toray Co., Ltd.): 10 parts

Carbon black: 10 parts

The above-listed coating materials were dispersed for 10 minutes by a stirrer, to thereby prepare a coating liquid. A coating device was charged with the prepared coating liquid and the core material to coat the core material with the coating liquid. The coating device was configured to perform coating by forming a rotational flow of the coating liquid and the core material in the fluid bed, to which a rotational bottom plate disk, and a stirring blade had been provided. The obtained coated product was baked for 2 hours at 250° C. in an electric furnace, to thereby obtain a carrier.

### <Production of Two-Component Developer>

A carrier, which contained particles each coated with a silicone resin to give the average thickness of 0.5 μm, and had the average particle diameter of 35 μm, was used. To 100 parts of the carrier, 7 parts of the toner was homogeneously mixed to charge the toner using a tubular mixer that was a type where a container thereof was rolled to stir the contents, to thereby produce a two-component developer.

Subsequently, the produced toner and two-component developer were subjected to evaluations of various properties, in the following manners.

### <Evaluation Device>

As an evaluation device, a modified image forming apparatus (imagio MP C6000, manufactured by Ricoh Company Limited) in which a modification had been made mainly in a fixing section, was used. The linear velocity thereof was set to 380 mm/sec. Moreover, a fixing unit of the fixing section was adjusted to have fixing contact pressure of 30 N/cm², and fixing nip time of 30 ms. As for a surface of a fixing roller that was a fixing member, a tetrafluoroethylene-perfluoroalkylvinyl ether copolymer resin (PFA) was applied, and shaped, and a surface thereof was adjusted.

### <Low Temperature Fixability>

Low temperature fixability of the toner was evaluated with the minimum fixing temperature of the toner.

A solid image having a toner deposition amount of 0.85±0.1 mg/cm² was formed in the position of cardboard transfer paper (Photocopy printing sheet <135> manufactured by Ricoh Company Limited), which was 3.0 cm away from the edge of paper feeding direction. The samples prepared in the aforementioned manner were output with gradually increasing the temperature of the fixing roller. The temperature at which cold offset stopped occurring was determined as the minimum fixing temperature, and low temperature fixability of the toner was evaluated based on the following criteria. The result is presented in Table 2.

### [Evaluation Criteria]

A: lower than 110° C.

B: 110° C. or higher but lower than 120° C.

C: 120° C. or higher but lower than 130° C.

D: 130° C. or higher

### <Durability to Folding>

The durability to folding was evaluated in the following manner.

A solid image having a toner deposition amount of 0.85±0.1 mg/cm² was formed in the position of cardboard transfer paper (Photocopy printing sheet <135> manufactured by Ricoh Company Limited), which was 3.0 cm away from the edge of paper feeding direction. The sample was then output with the fixing roller temperature of 130° C. After strongly folding the obtained fixing image in a manner that a surface where the toner had been fixed came outside, the fixing image was again strongly folded in a manner that the toner surface came inside. The same folding process was repeated twice (3 times in total). Thereafter, the toner surface was sufficiently blown. The resulting image was evaluated based on the following criteria. The result is presented in Table 2.

### [Evaluation Criteria]

A: No difference was observed between the folded part and non-folded part.

B: The color of the folded part was slightly pale compared to the non-folded part.

C: The base paper was confirmed at part of the folding part.

D: The base paper was confirmed in the large part of the folding part.

E: The base paper was confirmed in the almost entire part of the folding part.

### <Heat Resistant Storage Stability>

The evaluation of heat resistant storage stability was performed by a penetration degree test.

A 50 mL glass container was charged with the toner, followed by leaving the glass container in a thermostat set at the temperature of 50° C. for 24 hours. The resulting toner was cooled to 24° C., and was subjected to a measurement of a penetration degree (mm) in accordance with the penetration degree test (JIS K2235-1991). The result is presented in Table 2. Note that, the larger the value of the penetration degree is, more excellent the heat resistant storage stability of the toner is. When the penetration degree is less than 5 mm, it is highly likely that a problem occurs on practical use.

### [Evaluation Criteria]

A: The penetration degree was 20 mm or greater.

B: The penetration degree was 10 mm or greater, but less than 20 mm.

C: The penetration degree was 5 mm or greater, but less than 10 mm.

D: The penetration degree was less than 10 mm.

### Example 2

[Toner 2] was obtained in the same manner as in Example 1, provided that [Non-Crystalline Polyester 2] described below was used as a non-crystalline polyester resin.

The physical properties of [Toner 2] are presented in Table 1, and the evaluation results are presented in Table 2.

### <Synthesis of Non-Crystalline Polyester Resin 2>

A vessel equipped with a stirrer and a thermoset was charged with 2,250 parts of [Prepolymer 1], 70 parts of [Ketimine Compound 1], and 2,500 parts of ethyl acetate, and the resulting mixture was stirred for 2 hours at 80° C., followed by removing the solvent for 8 hours at 30° C., to thereby obtain [Non-Crystalline Polyester Resin 2].

### Example 3

[Toner 3] was obtained in the same manner as in Example 1, provided that [Non-Crystalline Polyester 3] described below was used as a non-crystalline polyester resin.

The physical properties of [Toner 3] are presented in Table 1, and the evaluation results are presented in Table 2.

### <Synthesis of Non-Crystalline Polyester Resin 3>

A vessel equipped with a stirrer and a thermoset was charged with 2,250 parts of [Prepolymer 1], 70 parts of [Ketimine Compound 1], and 2,500 parts of ethyl acetate, and the resulting mixture was stirred for 6 hours at 80° C., followed by removing the solvent for 8 hours at 30° C., to thereby obtain [Non-Crystalline Polyester Resin 3].

### Example 4

[Toner 4] was obtained in the same manner as in Example 1, provided that [Polyester Resin 4 Containing Amorphous Segment and Crystalline Segment (Copolymer 4)] described below was used as a polyester resin containing an amorphous segment and a crystalline segment.

The physical properties of [Toner 4] are presented in Table 1, and the evaluation results are presented in Table 2.

### <Preparation of Polyester Resin 4 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5A, manufactured by Kiriyama Glass Co., Ltd.). The filtrate was collected in a recovery flask. The filtration cake was dried with the filter paper, and 50% of the dried filtration cake was added to the recovery flask containing the filtrate therein. The solvent was removed from the resulting mixture for 8 hours at 30° C., to thereby obtain [Polyester Resin 4 Containing Amorphous Segment and Crystalline Segment (Copolymer 4)].

### Example 5

[Toner 5] was obtained in the same manner as in Example 1, provided that [Polyester Resin 5 Containing Amorphous Segment and Crystalline Segment (Copolymer 5)] described below was used as a polyester resin containing an amorphous segment and a crystalline segment.

The physical properties of [Toner 5] are presented in Table 1, and the evaluation results are presented in Table 2.

### <Preparation of Polyester Resin 5 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. The solvent thereof was removed for 8 hours at 30° C., to thereby obtain [Polyester Resin 5 Containing Amorphous Segment and Crystalline Segment (Copolymer 5)].

### Example 6

[Toner 6] was obtained in the same manner as in Example 1, provided that [Aqueous Phase 6] described below was used as an aqueous phase.

The physical properties of [Toner 6] are presented in Table 1, and the evaluation results are presented in Table 2.

### <Preparation of Aqueous Phase 6>

Water (990 parts by mass), 83 parts of [Particle Dispersion Liquid 1], 37 parts of a 48.3% sodium dodecyldiphenyl ether disulfonate aqueous solution (ELEMINOL MON-7, manufactured by Sanyo Chemical Industries, Ltd.), and 90 parts of ethyl acetate were mixed together and stirred, to thereby obtain a milky white fluid, which was used as [Aqueous Phase 6].

### Example 7

[Toner 7] was obtained in the same manner as in Example 1, provided that [Aqueous Phase 7] described below was used as an aqueous phase.

The physical properties of [Toner 7] are presented in Table 1, and the evaluation results are presented in Table 2.

### <Preparation of Aqueous Phase 7>

Water (990 parts by mass), 83 parts of [Particle Dispersion Liquid 1], 37 parts of a 36.2% sodium dodecyldiphenyl ether disulfonate aqueous solution (ELEMINOL MON-7, manufactured by Sanyo Chemical Industries, Ltd.), and 90 parts of ethyl acetate were mixed together and stirred, to thereby obtain a milky white fluid, which was used as [Aqueous Phase 7].

### Example 8

[Toner 8] was obtained in the same manner as in Example 1, provided that [Polyester Resin 8 Containing Amorphous Segment and Crystalline Segment (Copolymer 8)] described below was used as a polyester resin containing an amorphous segment and a crystalline segment.

The physical properties of [Toner 8] are presented in Table 1, and the evaluation results are presented in Table 2.

### <Preparation of Polyester Resin 8 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. The filtration cake was dried with the filter paper, and 30% of the dried filtration cake was added to the recovery flask containing the filtrate therein. The solvent was removed from the resulting mixture for 8 hours at 30° C., to thereby obtain [Polyester Resin 8 Containing Amorphous Segment and Crystalline Segment (Copolymer 8)].

### Example 9

[Toner 9] was obtained in the same manner as in Example 1, provided that [Polyester Resin 9 Containing Amorphous Segment and Crystalline Segment (Copolymer 9)] described below was used as a polyester resin containing an amorphous segment and a crystalline segment.

The physical properties of [Toner 9] are presented in Table 1, and the evaluation results are presented in Table 2.

### <Preparation of Polyester Resin 9 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. Ethyl acetate (30 parts) of 25° C. was poured into Kiriyama Rohto, on which the filtration cake was remained, and then the filtrate was discarded. Subsequently, 30 parts of ethyl acetate of 50° C. was poured, and the filtrated was collected and added to the recovery flask. The solvent was removed from the resulting mixture for 8 hours at 30° C., to thereby obtain [Polyester Resin 9 Containing Amorphous Segment and Crystalline Segment (Copolymer 9)].

### Example 10

[Toner 10] was obtained in the same manner as in Example 1, provided that [Polyester Resin 10 Containing Amorphous Segment and Crystalline Segment (Copolymer 10)] described below was used as a polyester resin containing an amorphous segment and a crystalline segment.

The physical properties of [Toner 10] are presented in Table 1, and the evaluation results are presented in Table 2.

### <Preparation of Polyester Resin 10 Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. Ethyl acetate (30 parts) of 25° C. was poured into Kiriyama Rohto, on which the filtration cake was remained, and then the filtrate was added to the recovery flask. The solvent was removed from the resulting mixture for 8 hours at 30° C., to thereby obtain [Polyester Resin 10 Containing Amorphous Segment and Crystalline Segment (Copolymer 10)].

### Example 11

[Toner 11] was obtained in the same manner as in Example 1, provided that [Non-Crystalline Polyester Resin 11] described below was used as a non-crystalline polyester resin, and [Polyester Resin 11 Containing Amorphous Segment and Crystalline Segment (Copolymer 11)] described below was used as a polyester resin containing an amorphous segment and a crystalline segment.

The physical properties of [Toner 11] are presented in Table 1, and the evaluation results are presented in Table 2.

### <Synthesis of Non-Crystalline Polyester Resin 11>

A vessel equipped with a stirrer and a thermoset was charged with 2,250 parts of [Prepolymer 1], 60 parts of [Ketimine Compound 1], and 2,500 parts of ethyl acetate, and the resulting mixture was stirred for 4 hours at 80° C., followed by removing the solvent for 8 hours at 30° C., to thereby obtain [Non-Crystalline Polyester Resin 11].

### <Preparation of Polyester Resin 11 Containing Amorphous Segment and Crystalline Segment>

A reaction vessel equipped with a cooling tube, stirrer, and a nitrogen-inlet tube was charged with 2,250 parts of [Non-Crystalline Polyester Resin 11], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. Ethyl acetate (30 parts) of 25° C. was poured into Kiriyama Rohto, on which the filtration cake was remained, and then the filtrate was added to the recovery flask. The solvent was removed from the resulting mixture for 8 hours at 30° C., to thereby obtain [Polyester Resin 11 Containing Amorphous Segment and Crystalline Segment (Copolymer 11)].

### Example 12

[Toner 12] was obtained in the same manner as in Example 1, provided that [Non-Crystalline Polyester Resin 12] described below was used as a non-crystalline polyester resin, and [Polyester Resin 12 Containing Amorphous Segment and Crystalline Segment (Copolymer 12)] described below was used as a polyester resin containing an amorphous segment and a crystalline segment.

The physical properties of [Toner 12] are presented in Table 1, and the evaluation results are presented in Table 2.

### <Synthesis of Non-Crystalline Polyester Resin 12>

A vessel equipped with a stirrer and a thermoset was charged with 2,250 parts of [Prepolymer 1], 50 parts of [Ketimine Compound 1], and 2,500 parts of ethyl acetate, and the resulting mixture was stirred for 4 hours at 80° C., followed by removing the solvent for 8 hours at 30° C., to thereby obtain [Non-Crystalline Polyester Resin 12].

### <Preparation of Polyester Resin 12 Containing Amorphous Segment and Crystalline Segment>

A reaction vessel equipped with a cooling tube, stirrer, and a nitrogen-inlet tube was charged with 2,250 parts of [Non-Crystalline Polyester Resin 12], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. Ethyl acetate (30 parts) of 25° C. was poured into Kiriyama Rohto, on which the filtration cake was remained, and then the filtrate was added to the recovery flask. The solvent was removed from the resulting mixture for 8 hours at 30° C., to thereby obtain [Polyester Resin 12 Containing Amorphous Segment and Crystalline Segment (Copolymer 12)].

### Example 13

[Toner 13] was obtained in the same manner as in Example 1, provided that [Non-Crystalline Polyester Resin 13] described below was used as a non-crystalline polyester resin, and [Polyester Resin 13

Containing Amorphous Segment and Crystalline Segment (Copolymer 13)] described below was used as a polyester resin containing an amorphous segment and a crystalline segment.

The physical properties of [Toner 13] are presented in Table 1, and the evaluation results are presented in Table 2.

### <Synthesis of Non-Crystalline Polyester Resin 13>

A vessel equipped with a stirrer and a thermoset was charged with 2,250 parts of [Prepolymer 1], 40 parts of [Ketimine Compound 1], and 2,500 parts of ethyl acetate, and the resulting mixture was stirred for 4 hours at 80° C., followed by removing the solvent for 8 hours at 30° C., to thereby obtain [Non-Crystalline Polyester Resin 13].

### <Preparation of Polyester Resin 13 Containing Amorphous Segment and Crystalline Segment>

A reaction vessel equipped with a cooling tube, stirrer, and a nitrogen-inlet tube was charged with 2,250 parts of [Non-Crystalline Polyester Resin 13], 250 parts of [Crystalline Polyester Resin 1], and 2,000 parts of ethyl acetate, and the resulting mixture was stirred for 5 hours at 100° C. The resultant was cooled to 10° C. using ice bath, followed by filtering using KIRIYAMA filter paper (No. 5C, manufactured by Kiriyama Glass Co., Ltd.). The filtrate was collected in a recovery flask. Ethyl acetate (30 parts) of 25° C. was poured into Kiriyama Rohto, on which the filtration cake was remained, and then the filtrate was added to the recovery flask. The solvent was removed from the resulting mixture for 8 hours at 30° C., to thereby obtain [Polyester Resin 13 Containing Amorphous Segment and Crystalline Segment (Copolymer 13)].

### Comparative Example 1

[Toner 1′] was obtained in the same manner as in Example 1, provided that [Non-Crystalline Polyester Resin 1′] described below was used as a non-crystalline polyester resin.

The physical properties of [Toner 1′] are presented in Table 1, and the evaluation results are presented in Table 2.

### <Synthesis of Non-Crystalline Polyester Resin 1′>

A vessel equipped with a stirrer and a thermoset was charged with 2,250 parts of [Prepolymer 1], 70 parts of [Ketimine Compound 1], and 2,500 parts of ethyl acetate, and the resulting mixture was stirred for 0.5 hours at 50° C., followed by removing the solvent for 8 hours at 30° C., to thereby obtain [Non-Crystalline Polyester Resin 1′].

### Comparative Example 2

[Toner 2′] was obtained in the same manner as in Example 1, provided that [Non-Crystalline Polyester Resin 2′] described below was used as a non-crystalline polyester resin.

The physical properties of [Toner 2′] are presented in Table 1, and the evaluation results are presented in Table 2.

### <Synthesis of Non-Crystalline Polyester Resin 2′>

A vessel equipped with a stirrer and a thermoset was charged with 2,250 parts of [Prepolymer 1], 70 parts of [Ketimine Compound 1], and 2,500 parts of ethyl acetate, and the resulting mixture was stirred for 8 hours at 100° C., followed by removing the solvent for 8 hours at 30° C., to thereby obtain [Non-Crystalline Polyester Resin 2′].

### Comparative Example 3

[Toner 3′] was obtained in the same manner as in Example 1, provided that [Polyester Resin 3′ Containing Amorphous Segment and Crystalline Segment (Copolymer 3′)] described below was used as a polyester resin containing an amorphous segment and a crystalline segment.

The physical properties of [Toner 3′] are presented in Table 1, and the evaluation results are presented in Table 2.

### <Preparation of Polyester Resin 3′ Containing Amorphous Segment and Crystalline Segment>

A reaction vessel equipped with a cooling tube, stirrer, and a nitrogen-inlet tube was charged with 2,250 parts of [Non-Crystalline Polyester Resin 1], 250 parts of [Crystalline Polyester Resin 1], and 2,000 parts of ethyl acetate, and the resulting mixture was stirred for 5 hours at 100° C. The solvent was removed from the resulting mixture for 8 hours at 30° C., to thereby obtain [Polyester Resin 3′ Containing Amorphous Segment and Crystalline Segment (Copolymer 3′)].

### Comparative Example 4

[Toner 4′] was obtained in the same manner as in Example 1, provided that [Aqueous Phase 4′] described below was used as an aqueous phase.

The physical properties of [Toner 4′] are presented in Table 1, and the evaluation results are presented in Table 2.

### <Preparation of Aqueous Phase 4′>

Water (990 parts by mass), 83 parts of [Particle Dispersion Liquid 1], 37 parts of a 24.1% sodium dodecyldiphenyl ether disulfonate aqueous solution (ELEMINOL MON-7, manufactured by Sanyo Chemical Industries, Ltd.), and 90 parts of ethyl acetate were mixed together and stirred, to thereby obtain a milky white fluid, which was used as [Aqueous Phase 4′].

TABLE 1

| | | HFIP | | | | | |
|---|---|---|---|---|---|---|---|
| | | | | | Peak area of | | |
| | | | Number of | Peak area at | second and | | Molecular |
| | | | peaks at | high | further | | weight |
| | | | high | molecular | peaks from | | difference |
| | | | molecular | weight side | the closest | Half value | between |
| | THF | | weight side | of Pmax | peak to | width of | Pmax and |
| | M_{THF} | M_{Pmax} | of Pmax | (%) | Pmax (%) | Pmax | Pmax + 1 |
| Ex. 1 | 1.2 × 10⁴ | 2.1 × 10⁴ | 2 | 22 | 25 | 2.4 × 10⁴ | — |
| Ex. 2 | 4.5 × 10³ | 2.8 × 10⁴ | 2 | 21 | 24 | 2.3 × 10⁴ | — |
| Ex. 3 | 9.0 × 10⁵ | 3.4 × 10⁴ | 2 | 22 | 25 | 2.4 × 10⁴ | — |
| Ex. 4 | 1.2 × 10⁴ | 2.1 × 10⁴ | 2 | 34.9 | 29 | 2.1 × 10⁴ | — |
| Ex. 5 | 1.5 × 10⁴ | 2.1 × 10⁴ | 0 | — | — | 2.4 × 10⁴ | — |
| Ex. 6 | 1.1 × 10⁴ | 2.1 × 10⁴ | 2 | 20 | 22 | 2.7 × 10⁴ | — |
| Ex. 7 | 1.3 × 10⁴ | 2.2 × 10⁴ | 2 | 20 | 18 | 3.4 × 10⁴ | — |
| Ex. 8 | 1.3 × 10⁴ | 2.1 × 10⁴ | 2 | 21 | 14.8 | 2.5 × 10⁴ | — |
| Ex. 9 | 1.3 × 10⁴ | 2.1 × 10⁴ | 1 | 24 | — | 2.1 × 10⁴ | 8.2 × 10⁴ |
| Ex. 10 | 1.0 × 10⁴ | 2.2 × 10⁴ | 1 | 20 | — | 2.5 × 10⁴ | 7.9 × 10⁴ |
| Ex. 11 | 9.0 × 10³ | 1.9 × 10⁴ | 1 | 22 | — | 2.3 × 10⁴ | 7.8 × 10⁴ |
| Ex. 12 | 4.5 × 10³ | 5.2 × 10³ | 1 | 22 | — | 2.3 × 10⁴ | 7.7 × 10⁴ |
| Ex. 13 | 4.2 × 10³ | 4.8 × 10³ | 1 | 22 | — | 2.2 × 10⁴ | 7.6 × 10⁴ |
| Comp. | 3.8 × 10³ | 4.5 × 10³ | 2 | 23 | 24 | 2.4 × 10⁴ | — |
| Ex. 1 | | | | | | | |
| Comp. | 1.2 × 10⁶ | 4.2 × 10⁴ | 2 | 22 | 24 | 2.4 × 10⁴ | — |
| Ex. 2 | | | | | | | |
| Comp. | 1.1 × 10⁴ | 2.1 × 10⁴ | 2 | 38 | 30 | 2.2 × 10⁴ | — |
| Ex. 3 | | | | | | | |
| Comp. | 1.0 × 10⁴ | 2.1 × 10⁴ | 2 | 21 | 16 | 4.2 × 10⁴ | — |
| Ex. 4 | | | | | | | |

TABLE 2

| | Low temperature | Durability to | Heat resistant |
|---|---|---|---|
| | fixability | folding | storage stability |
| Ex. 1 | B | D | B |
| Ex. 2 | B | D | C |
| Ex. 3 | C | D | B |
| Ex. 4 | C | D | B |
| Ex. 5 | A | A | B |
| Ex. 6 | B | C | C |
| Ex. 7 | C | D | C |
| Ex. 8 | B | C | B |
| Ex. 9 | A | C | B |
| Ex. 10 | A | B | B |
| Ex. 11 | A | A | B |
| Ex. 12 | A | A | B |
| Ex. 13 | A | A | C |
| Comp. | B | D | D |
| Ex. 1 | | | |
| Comp. | C | E | B |
| Ex. 2 | | | |
| Comp. | D | E | B |
| Ex. 3 | | | |
| Comp. | D | E | D |
| Ex. 4 | | | |

For example, the embodiments of the present invention are as follows:

<1> A toner, including:

a colorant;

a resin; and

a release agent,

wherein M_{THF} is 4.0×10³ to 1.0×10⁶, where M_{THF} is a molecular weight of a peak-top of a peak whose differential molecular distribution value is maximum in a differential molecular weight distribution curve derived from the resin, the differential molecular weight distribution curve being obtained by gel permeation chromatography (GPC) of the toner using tetrahydrofuran (THF) as a solvent, and

wherein there is no peak at a higher molecular weight side of a maximum peak (Pmax) present at a molecular weight of 5×10⁴ or less in a molecular weight distribution derived from the resin, which the molecular weight distribution being obtained by GPC of the toner using hexafluoroisopropanol (HFIP) as a solvent, or there are one or more peaks at the higher molecular weight of the Pmax, a total peak area is 35% or less of an area of the Pmax, and the Pmax has a half value width of 3.5×10⁴ or less.

<2> The toner according to <1>, wherein there are two or more peaks at the higher molecular weight side of the Pmax in the molecular weight distribution derived from the resin, the molecular weight distribution being obtained by GPC of the toner using HFIP as a solvent, and a total peak area of the peaks that are second and subsequent peaks counted from the peak closest to the Pmax is 15% or less of the area of the Pmax.
<3> The toner according to <1> or <2>, wherein there is only one peak at the higher molecular weight side of the Pmax in the molecular weight distribution derived from the resin, the molecular weight distribution being obtained by GPC using HFIP as a solvent.
<4> The toner according to any one of <1> to <3>, wherein there is only one peak at the higher molecular weight side of the Pmax in the molecular weight distribution derived from the resin, the molecular weight distribution being obtained by GPC using HFIP as a solvent, and a difference in a molecular weight between the Pmax and the only one peak is 8×10⁴ or less.
<5> The toner according to any one of <1> to <4>, wherein a molecular weight (M_{Pmax}) of a peak-top of the Pmax is 5.0×10³ to 2.0×10⁴ in the molecular weight distribution derived from the resin, the molecular weight distribution being obtained by GPC of the toner using HFIP.
<6> A two-component developer, including:

the toner according to any one of <1> to <5>; and

a carrier having magnetism.

<7> A toner accommodating unit, including:

the toner according to any one of <1> to <5>.

<8> An image forming apparatus, including:

a latent image bearer;

a charging unit configured to charge a surface of the latent image bearer;

an exposing unit configured to expose the surface charged of the latent image bearer to light to form an electrostatic latent image;

a developing unit containing a toner and configured to develop the electrostatic latent image with the toner to form a visible image;

a transferring unit configured to transfer the visible image onto a recording medium; and

a fixing unit configured to fix the visible image on the recording medium with heat and pressure applied by a fixing member,

wherein the toner is the toner according to any one of <1. To <5>.

<9> The image forming apparatus according to <8>, wherein the image forming apparatus is a tandem image forming apparatus, in which at least four image forming elements, each containing the latent image bearer, the charging unit, the developing unit, and the transferring unit, are provided in series.
<10> The image forming apparatus according to <8> or <9>, wherein a system speed of the image forming apparatus is 200 mm/sec to 3,000 mm/sec, a contact pressure applied by the fixing member is 10 N/cm² to 3,000 N/cm², and a fixing nip time is 30 msec to 400 msec.
<11> An image forming method, including:

charging a surface of a latent image bearer;

exposing the surface charged of the latent image bearer to light to form an electrostatic latent image;

developing the electrostatic latent image with a toner to form a visible image;

transferring the visible image onto a recording medium; and

fixing the visible image on the recording medium with heat and pressure applied by a fixing member,

wherein the toner is the toner according to any one of <1> to <5>.

<12> A process cartridge, including:

a latent image bearer; and

a developing unit containing a toner and configured to develop an electrostatic latent image formed on the latent image bearer with the toner to form a visible image,

wherein the toner is the toner according to any one of <1> to <5>.

This application claims priority to Japanese application No. 2014-226136, filed on Nov. 6, 2014 and incorporated herein by reference.

What is claimed is:

1. A toner, comprising:
a colorant;
a resin; and
a release agent,
wherein M_{THF} is 4.0×10³ to 1.0×10⁶, where M_{THF} is a molecular weight of a peak-top of a peak whose differential molecular distribution value is maximum in a differential molecular weight distribution curve derived from the resin, the differential molecular weight distribution curve being obtained by gel permeation chromatography (GPC) of the toner using tetrahydrofuran (THF) as a solvent, and
wherein there is no peak at a higher molecular weight side of a maximum peak (Pmax) present at a molecular weight of 5×10⁴ or less in a molecular weight distribution derived from the resin, the molecular weight distribution being obtained by GPC of the toner using hexafluoroisopropanol (HFIP) as a solvent, or there are one or more peaks at the higher molecular weight of the Pmax, a total peak area is 35% or less of an area of the Pmax, and the Pmax has a half value width of 3.5×10⁴ or less.

2. The toner according to claim 1, wherein there are two or more peaks at the higher molecular weight side of the Pmax in the molecular weight distribution derived from the resin, the molecular weight distribution being obtained by GPC of the toner using HFIP as a solvent, and a total peak area of the peaks that are second and subsequent peaks counted from the peak closest to the Pmax is 15% or less of the area of the Pmax.

3. The toner according to claim 1, wherein there is only one peak at the higher molecular weight side of the Pmax in the molecular weight distribution derived from the resin, the molecular weight distribution being obtained by GPC using HFIP as a solvent.

4. The toner according to claim 1, wherein there is only one peak at the higher molecular weight side of the Pmax in the molecular weight distribution derived from the resin, the molecular weight distribution being obtained by GPC using HFIP as a solvent, and a difference in a molecular weight between the Pmax and the only one peak is 8×10⁴ or less.

5. The toner according to claim 1, wherein a molecular weight (M_{Pmax}) of a peak-top of the Pmax is 5.0×10³ to 2.0×10⁴ in the molecular weight distribution derived from the resin, the molecular weight distribution being obtained by GPC of the toner using HFIP.

6. A toner accommodating unit, comprising:
the toner according to claim 1.

7. An image forming apparatus, comprising:
a latent image bearer;
a charging unit configured to charge a surface of the latent image bearer;
an exposing unit configured to expose the surface charged of the latent image bearer to light to form an electrostatic latent image;
a developing unit containing a toner and configured to develop the electrostatic latent image with the toner to form a visible image;
a transferring unit configured to transfer the visible image onto a recording medium; and
a fixing unit configured to fix the visible image on the recording medium with heat and pressure applied by a fixing member,
wherein the toner is the toner according to claim 1.

8. The image forming apparatus according to claim 7, wherein the image forming apparatus is a tandem image forming apparatus, in which at least four image forming elements, each containing the latent image bearer, the charging unit, the developing unit, and the transferring unit, are provided in series.

9. The image forming apparatus according to claim 7, wherein a system speed of the image forming apparatus is 200 mm/sec to 3,000 mm/sec, a contact pressure applied by the fixing member is 10 N/cm² to 3,000 N/cm², and a fixing nip time is 30 msec to 400 msec.

10. An image forming method, comprising:
charging a surface of a latent image bearer;
exposing the surface charged of the latent image bearer to light to form an electrostatic latent image;
developing the electrostatic latent image with a toner to form a visible image;
transferring the visible image onto a recording medium; and
fixing the visible image on the recording medium with heat and pressure applied by a fixing member,
wherein the toner is the toner according to claim 1.

11. A process cartridge, comprising:
a latent image bearer; and
a developing unit containing a toner and configured to develop an electrostatic latent image formed on the latent image bearer with the toner to form a visible image,
wherein the toner is the toner according to claim 1.
